(19) United States
(12) Patent Application Publication
(10) Pub. No.: US 2006/0167772 A1
(43) Pub. Date: Jul. 27, 2006

(54) Electronic interpretation of financials

(76) Inventor: Ran Zilberman, Tel Aviv (IL)

Correspondence Address: BROWDY AND NEIMARK, P.L.L.C.;624 NINTH STREET, NW, SUITE 300, WASHINGTON, DC, 20001-5303, US

(21) Appl. No.: 10/533,445

(22) PCT Filed: Oct. 30, 2003
(86) PCT No.: PCT/IL03/00897

§ 371 Date: Nov. 14, 2005

Related U.S. Application Data
(60) Provisional application No. 60/422,141, filed on Oct. 30, 2002.

(51) Int. Cl. G06Q 40/00

(52) U.S. Cl. 705/35

(57) ABSTRACT

Disclosed are methods and systems for electronically analyzing primarily financial information of an entity. One method comprises: receiving primarily financial inputs related to an entity; and for at least one predetermined relationship: looking up which at least two variables are linked to the predetermined relationship, determining values of the at least two linked variables, evaluating the relationship using the determined values, selecting less than all interpretative paragraphs associated with the relationship based on results of the evaluating, and outputting the selected less than all paragraphs.

### FIELD AND BACKGROUND OF THE INVENTION

The present invention relates to analysis of financial information of an (economic and/or legal) entity.

Financial analysis typically involves two phases. The first phase is the number crunching phase. An entity's financial numbers, for example from the entity's financial statements such as the income statement, balance sheet, cash flow statement, and/or statement of stockholders' equity, notes that are used to calculate financial ratios, percentages of total assets or sales, percentage or dollar change from previous periods, variations in percentages of total assets or sales compared to previous periods, variations in percentages of total assets or sales compared to industry averages or other entities, etc. Often, the first phase is performed by an electronic system, programmed to perform predetermined calculations.

The second phase is the interpretation of the results of the calculations. Typically the calculation results are interpreted by a financial analyst internal or external to the entity whose financials are being analyzed. For example, financial analysts are employed by investment banks to recommend appropriate stock buys.

There are a number of problems with the above approach. First, there is typically a lack of customization, flexibility and modularity because the electronic system performs the same calculations, regardless of the characteristics of the analyzed entity and/or the preferences of the user of the electronic system. Second, the interpretation relies inter-alia on the integrity, experience, talent, professionalism, objectivity and ability of the financial analyst. A particular financial analyst may be biased in his or her interpretation of the calculation results, may fail to grasp the significance of a given output and/or is subject to human error. Third, not everyone may have access to the expertise of a financial analyst or alternatively the ability to interpret the calculation results by oneself. Note that the specified analysis procedure requires considerable time and cost resources.

In the related art, US 20020019791A to Goss et al describes an electronic system which provides financial advice based on personal data and financial objectives entered by users, by means of a rules engine. The rules engine detects whether the financial objectives match the personal data provided by the user and issues a challenge, or initiates a communication with a financial adviser, if they do not. The system stores general financial information and automatically provides updated financial advice to the user when the general financial information changes. The financial advice is in the form of a document compiled from text passages selected by matching predefined values to the user's personal data. The data and rules used to generate the financial advice are stored so as to be available for inspection, to demonstrate compliance with financial regulations.

### SUMMARY OF THE INVENTION

According to the present invention there is provided a method of electronically analyzing primarily financial information of an entity, comprising: receiving primarily financial inputs related to an entity ; and for at least one predetermined relationship: looking up which at least two variables are linked to the predetermined relationship, determining values of the at least two linked variables, evaluating the relationship using the determined values, selecting less than all interpretative paragraphs associated with the relationship based on results of the evaluating, and outputting the selected less than all paragraphs.

According to the present invention there is also provided a system for electronically analyzing primarily financial information of an entity, comprising: at least one storage configured to store a plurality of relationships, variables linked to the plurality of relationships and interpretive paragraphs associated with the plurality of relationships; an input configured to receive primarily financial inputs related to an entity; a calculator configured to calculate values of the variables from the received inputs; an evaluator configured to evaluate the relationships for the values of the variables; a selector configured to select less than all paragraphs associated with the relationships based on results of the evaluator; and an output configured to output the selected less than all paragraphs.

According to the present invention there is further provided a method for electronically analyzing primarily financial information of an entity, comprising: receiving primarily financial inputs related to an entity; and outputting a textual description and interpretation of a financial state of the entity.

According to the present invention there is still further provided a system for electronically analyzing primarily financial information of an entity, comprising: an input for receiving primarily financial inputs related to an entity; and an output for outputting a textual description and interpretation of a financial state of the entity.

According to the present invention there is provided a method of electronically analyzing primarily financial information of an entity, comprising: receiving primarily financial inputs related to an entity; and for at least one predetermined relationship: looking up which at least one variable is linked to the predetermined relationship, determining a value of the at least one linked variable, evaluating the relationship using the determined value, selecting or not selecting at least one of at least one interpretative paragraph associated with the relationship based on results of the evaluating, and if at least one of said paragraphs has been selected, outputting the selected at least one of the paragraphs.

According to the present invention there is also provided a system for electronically analyzing primarily financial information of an entity, comprising: at least one storage configured to store a plurality of relationships, variables linked to the plurality of relationships and interpretive paragraphs associated with the plurality of relationships; an input configured to receive primarily financial inputs related to an entity; a calculator configured to calculate values of the variables from the received inputs; an evaluator configured to evaluate the relationships for the values of the variables; a selector configured to select or not select interpretive paragraphs associated with the relationships based on results of the evaluator; and an output configured to output any selected paragraphs.

According to the present invention there is provided a program storage device readable by machine, tangibly embodying a program of instructions executable by the machine to perform method stages of electronically analyzing primarily financial information of an entity, comprising: receiving primarily financial inputs related to an entity ; and for at least one predetermined relationship: looking up which at least two variables are linked to the predetermined relationship, determining values of the at least two linked variables, evaluating the relationship using the determined values, selecting less than all interpretative paragraphs associated with the relationship based on results of the evaluating, and outputting the selected less than all paragraphs.

According to the present invention there is also provided a computer program product comprising a computer useable medium having computer readable program code embodied therein for electronically analyzing primarily financial information of an entity, the computer program product comprising: computer readable program code for causing the computer to receive primarily financial inputs related to an entity ; and

computer readable program code for causing the computer to for at least one predetermined relationship: look up which at least two variables are linked to the predetermined relationship, determine values of the at least two linked variables, s evaluate the relationship using the determined values, select less than all interpretative paragraphs associated with the relationship based on results of the evaluating, and output the selected less than all paragraphs.

According to the present invention there is further provided a program storage device readable by machine, tangibly embodying a program of instructions executable by the machine to perform method stages of electronically analyzing primarily financial information of an entity, comprising: receiving primarily financial inputs related to an entity; analyzing primarily financials of an entity, based on said inputs; and outputting a textual description and interpretation of a financial state of the entity.

According to the present invention there is still further provided a computer program product comprising a computer useable medium having computer readable program code embodied therein for electronically analyzing primarily financial information of an entity, the computer program product comprising: computer readable program code for causing the computer to receive primarily financial inputs related to an entity; analyzing primarily financials of an entity, based on said inputs; and computer readable program code for causing the computer to output a textual description and interpretation of a financial state of the entity.

According to the present invention there is provided a program storage device readable by machine, tangibly embodying a program of instructions executable by the machine to perform method stages of electronically analyzing primarily financial information of an entity, comprising: receiving primarily financial inputs related to an entity; and for at least one predetermined relationship: looking up which at least one variable is linked to the predetermined relationship, determining a value of the at least one linked variable, evaluating the relationship using the determined value, selecting or not selecting at least one of at least one interpretative paragraph associated with the relationship based on results of the evaluating, and if at least one of the paragraphs has been selected, outputting the selected at least one of the paragraphs.

According to the present invention there is also provided a computer program product comprising a computer useable medium having computer readable program code embodied therein for electronically analyzing primarily financial information of an entity, the computer program product comprising: computer readable program code for causing the computer to receive primarily financial inputs related to an entity; and computer readable program code for causing the computer to for at least one predetermined relationship: look up which at least one variable is linked to the predetermined relationship, determine a value of the at least one linked variable, evaluate the relationship using the determined value, select or not select at least one of at least one interpretative paragraph associated with the relationship based on results of the evaluating, and if at least one of the paragraphs has been selected, output the selected at least one of the paragraphs.

### BRIEF DESCRIPTION OF THE DRAWINGS

The invention is herein described, by way of example only, with reference to the accompanying drawings, wherein:

FIG. 1 is a flowchart of a method of electronically analyzing financial information of an entity, in accordance with a preferred embodiment of the present invention;

FIG. 2 is a block diagram of a system for electronically analyzing financial information of an entity, in accordance with a preferred embodiment of the present invention;

FIG. 3 is an example of part of a look up table listing relationships and linked variables, in accordance with a preferred embodiment of the present invention;

FIG. 4 is a flowchart of a method of electronically analyzing financial information of an entity, in accordance with another preferred embodiment of the present invention; and

FIG. 5 is a block diagram of a system for electronically analyzing financial information of an entity, in accordance with another preferred embodiment of the present invention.

### DESCRIPTION OF THE PREFERRED EMBODIMENTS

The description below refers occasionally to Appendices A-K attached herewith and entitled:

Appendix A is a balance sheet of Impreso, Inc.;

Appendix B is an income statement of Impreso, Inc.;

Appendix C is a cash flow statement of Impreso, Inc.;

Appendix D illustrates calculations of values of balance sheet related variables for Impreso, Inc.;

Appendix E illustrates calculations of values of income statement related variables for Impreso, Inc.;

Appendix F illustrates interpretive texts in the database which are associated with a fifth sample relationship, in accordance with a preferred embodiment of the present invention;

Appendix G illustrates interpretive paragraphs in the database which are associated with a sixth sample relationship, in accordance with a preferred embodiment of the present invention;

Appendix H illustrates interpretive paragraphs in the database which are associated with a seventh sample relationship, in accordance with a preferred embodiment of the present invention;

Appendix I illustrates calculations of values of cash flow statement related variables for Impreso, Inc.;

Appendix J illustrates interpretive paragraphs in the database which are associated with a eighth sample relationship, in accordance with a preferred embodiment of the present invention;

Appendix K illustrates interpretive paragraphs in the database which are associated with a ninth sample relationship, in accordance with a preferred embodiment of the present invention;

The present invention is of a method and system for electronically interpreting the financials of an entity, for example the financial statements or financial data of an entity. The entity can be inter-alia one or more non-profit organization, one or more governmental agency, one or more public company, one or more private company, one or more partnership, one or more joint venture, one or more corporate, one or more conglomerate one or more family, one or more person, etc.

Note that the method and system of the invention can be implemented, in advance, thereby providing a repertoire of off-the-shelf reports of various entities, each including interpretation of financials of an entity. Alternatively, the method and system of the invention can be implemented on ad-hoc basis (i.e. upon user request) for providing a report that includes interpretation of financials of an entity of interest.

Note also that whenever reference is made to previous period(s) it likewise applies to corresponding or parallel periods.

In one preferred embodiment, a list of predetermined financial relationships are interpreted. In another preferred embodiment, the predetermined relationships on the list are selectively interpreted depending on results of significance tests, if any, associated with a particular relationship and/or whether a particular relationship conforms to criteria defined by a user of the electronic system.

The principles and operation of electronic interpretation of financials of an entity according to the present invention may be better understood with reference to the drawings and the accompanying description. All examples below are non-limiting illustrations of the invention described and defined herein.

For the sake of illustration, the financial statements of a public company, Impreso, Inc will be discussed. The usage of the financial statements of Impreso, Inc is arbitrary and has no bearing on the invention. The balance sheet, income statement, and cash flow statement of Impreso, as published, are shown in Appendices A, B and C. respectively. In the description below, the given period is assumed to be year ended Aug. 31, 2001 and the preceding period is assumed to be year ended Aug. 31, 2000. Note that there are errors on the published cash flow statement for net cash used in investing activities, net increase/decrease in cash and end of year cash for years 1999 and 2000. These errors are rectified in -Appendix I. The invention is not bound by the specified financial statements and accordingly other forms of financial statements and/or financial data may be used.

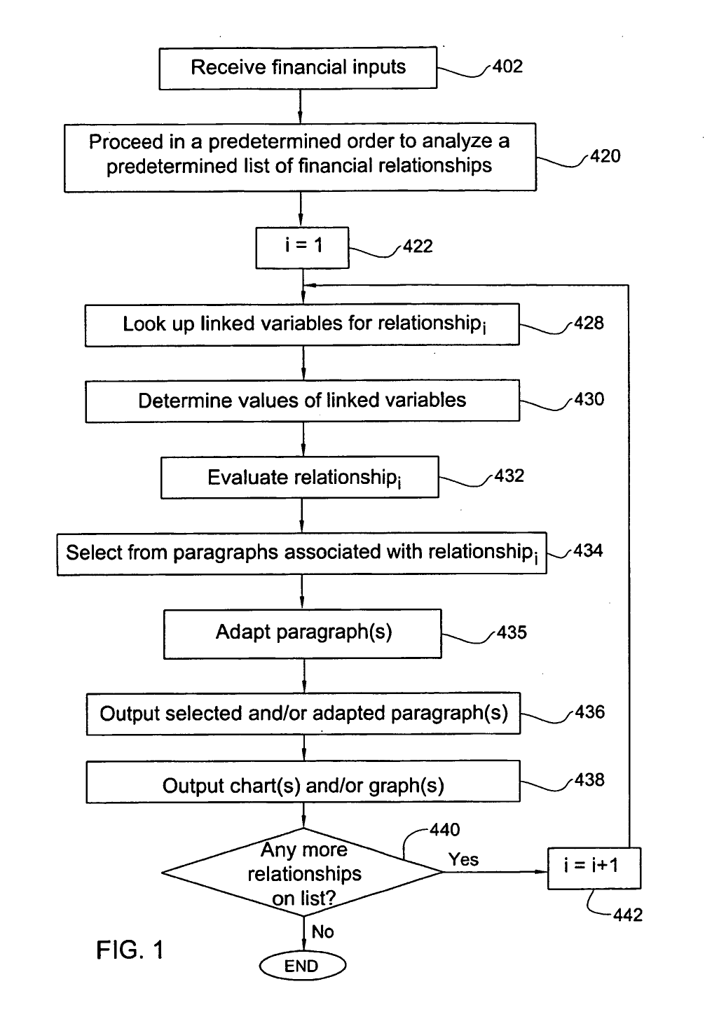

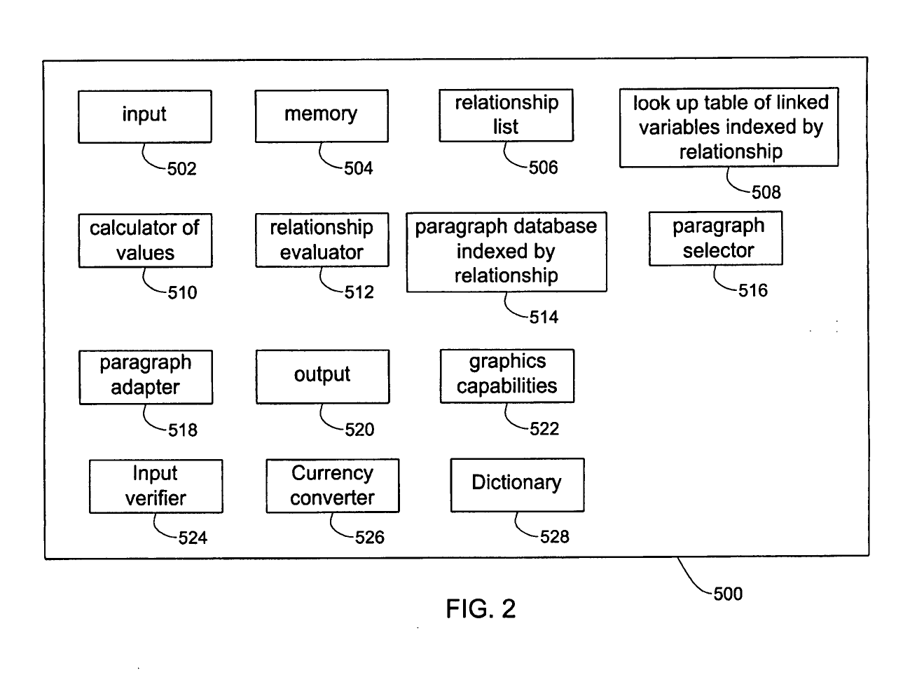

A method of a preferred embodiment of the invention is shown in FIG. 1. A preferred embodiment of an electronic system 500 to execute the method of FIG. 1 is shown in FIG. 2. System 500 can be made up of any combination of software, hardware and/or firmware. For example, system 500 can be inter-alia a computer, a land telephone device, a cellular telephone device, a personal digital assistant PDA, a software program, a programmable chip, etc. The division into modules shown in FIG. 2 are for ease of understanding and in other embodiments a module may be separated into a plurality of modules or alternatively combined with other modules. System 500 may be located at a user location, for example on a user personal computer or system 500 may be located remotely from a user, for example on a server with which the user communicates via, say the Internet or through cellular infrastructure.

In stage 402, an input 502 of electronic system 500 receives inputs, primarily financial, related to an entity. Although the receiving is shown as one stage, it should be evident that not all inputs need to be necessarily received by system 500 at the same time. The received financials of an entity, i.e. inputs related to the entity can include one or more of the following inter-alia: partial or complete entity income statement for a given period, partial or complete entity income statement for previous period(s), partial or complete entity balance sheet for the given period, partial or complete entity balance sheet for previous period(s), partial or complete entity statement of cash-flow for the given period, partial or complete entity statement of cash flow for previous period(s), partial or complete entity statement of stockholders' equity for the given period, partial or complete entity statement of stockholders' equity for previous period(s), entity footnotes from the quarterly or annual report, for example those appearing on the financial statements, number of years of entity operation, currency, length of period (for example annual or quarterly), entity labor force size, entity plant size, number of countries where entity has a presence, macro-economic factors (for example prime rate, inflation rate, currency exchange rates), industry averages, competitor (herein below including a plurality of competitors) and/or other entity information such as financials, notes of the financial statements, text data, risk analysis, problems of hedging stock exchange data valuation by analysts, taxation, etc. Whenever applicable, the input can be received inter alia as a standard input format (such as 10K format), directly (or after conversion) from the accounting system or information system, etc.

Note that inputs such as macro-economic factors, industry averages, and competitor and/or other entity information, etc. are also considered herein below as relating to the entity because these inputs may affect the performance or the interpretation of the performance of the entity. The input may further include also qualitative information, from internal or external sources, e.g., resignation of management, substantial court suits, comments in the CPA report etc.

Techniques in which inputs can be received by electronic system 500 are well known in the art and include inter alia one or a combination of the following: scanning (possibly with an associated character recognition modules), keyboard entering, pull down menus, voice input receipt via a communication medium such as a cellular network or the Internet in an automatic or non-automatic fashion by push or pull, downloading from Internet sites, etc. Depending on the techniques supported by a particular embodiment, input 502 includes the means which allows those techniques, for example a keyboard, a mouse, a connection to a communication medium, a stylus, voice recognition system, etc.

For example for keyboard entering, in one embodiment the user may enter the inputs of an entity onto a template which is processed by electronic system 500, whereas in another embodiment, the user may enter the financial inputs in a format corresponding to the published financial statements of the entity.

In one embodiment, the user selects from pull down menus the values of certain inputs from among predefined possibilities, for example the user selects whether the entity handles goods or provides a service, the industry to which the entity belongs (for example food, textile, etc), the country where the entity is headquartered, the currency, the period (for example first quarter 2002), etc.

In one embodiment, system 500 receives automatic (or manual) updates of industry averages and/or macro-economic factors from Internet sites or other source on a periodic or continuous basis (i.e. input 502 is connected to a communication medium in order to receive these updates). Examples of sites from which system 500 may receive updates include inter alia financial newspapers on-line, accounting firm sites, information agency sites such as Bloomberg or Reuters, site3 which specialize in gathering business information, Industry surveys, databases (e.g. Dialog), sites (e.g. (EDGAR), governmental and/or public information sources, etc.

In one embodiment, system 500 receives entity inputs which were input by the user previously, for example inputs related to previous period(s), from an external storage, for example from a storage disk or web server. In one alternative embodiment, previously received inputs are retained by system 500 for example in a memory 504 and receiving stage 402 for these previously received inputs relates to the earlier point in time at which these inputs were received.

Optionally, the received inputs are checked for accuracy by an optional input verifier 524, for example to verify that an input balance sheet balances, that an input net income equals a net income calculated from other income statement inputs, etc. In some of these optional embodiments, the user is consulted or informed if there is an error while in other of these optional embodiments, the errors are corrected without consultation or notification of the user. An example of the latter option (where automatic error correction is implemented) is a scenario in which the Impreso published cash flow statement (presented in Appendix C) were scanned into system 500, and verifier 524 would correct the errors in the inputs on the cash flow statement prior to using those inputs in calculations.

Also optionally, the inputs can be converted to a desired currency by an optional currency converter 526. For ease of explanation in the description below it is assumed that the described inputs have been received in or converted to the US currency as is the case for Impreso, Inc..

Also optionally (not shown in the Figures), the input is categorized by state/country, possibly broken down by, say industry and or sector (according to user selection). Note that the system may store repertoire of reports, surveys, analysis and macro economic parameters (possibly categorized by state/country, and if desired, broken down by, say industry and or sector) which may be subjected to automatic and/or manual updates in pre-defined or ad-hoc frequency.

Optionally inputs may be annualized (or other period), for example using a calculator 510. For ease of explanation in the description below it is assumed that the described inputs are for a 12 month period, as is the case for the illustrated financial statements of Impreso, Inc.

System 500 can also include an optional dictionary 528 to provide an explanation of a term used by the system, a definition of an acronym to the user, etc. For example an entry for COGS can state “COGS is an acronym for cost of goods sold and is a figure representing the cost of buying raw materials and producing finished goods . . . ”. Alternatively and optionally, system 500 can be linked to an external dictionary through a communication medium. In one embodiment with a dictionary option, dictionary 528 or the external dictionary includes extensive information on financial topics and is therefore similar to an encyclopedia.

For ease of explanation, the inputs are assumed to be stored in memory 504, at least until the inputs are no longer required for performing the method of FIG. 1 or as long as the user requires them.

In stage 420, system 500 proceeds in a predetermined order to analyze a predetermined list 506 of financial relationships. Associated with the financial relationships are one or more paragraphs stored in a database 514, indexed for example by relationship.

In stage 428, system 500 looks up which variables are linked to relationship (where i ranges from 1 to the number of relationships in list 506). For example, system 500 can consult a look-up table 508 whose entries are indexed by relationship. In stage 430, the values of the linked variables for relationship are determined, for example through computation by calculator 510, or through retrieval from a memory such as memory 504 if the values had been previously computed and stored.

If computation is necessary, the value for each linked variable may preferably be calculated from one or more inputs. For example a particular variable may be identical to an input. In another example, a particular variable may represent one input as a percent of another input, as is common when calculating entity, competitor and/or other entity, and/or industry common size statements for a period. In another example, a variable may represent the dollar change between two or more inputs, with a first input corresponding to a first period and a second input corresponding to a following period. In another example, a variable may represent the percentage change between two or more inputs, with a first input corresponding to a first period and a second input corresponding to a following period, etc.. In another example, a variable may represent a change in percent of total assets or percent of sales between periods. In another example, a variable may represent a difference in percent of total assets or percent of sales between an entity and the industry average or competitor (and/or other entity). In another example, a variable can represent a difference or a sum of a plurality of inputs, for example represent EBITDA or EBIT. In another example, a variable may represent a financial ratio, such as for example activity ratios (inventory turnover, days inventory, accounts receivable turnover, days accounts receivables, working capital turnover, fixed assets turnover, total assets turnover, etc.) liquidity ratios (days payable, current ratio, quick ratio, cash ratio, cash flow from operations ratio, defensive interval, etc.), solvency ratios (debt to total capital, debt to equity, total debt at book value to equity at market, times interest earned, fixed charge coverage, times interest earned (cash basis), fixed charge coverage ratio (cash basis), capital expenditure ratio, cash from operations to total debt, etc), Altman ratio (z-score analysis), or profitability ratios (gross margin, operating margin, margin before interest and tax, pretax margin, profit margin, contribution margin, return on assets, return on common equity, return on total equity, operating leverage effect, financial leverage effect, etc) for an entity, competitor or the industry to which the entity belongs. In another example, a variable can represent a weighted average of a plurality of financial ratios. In another example, calculation of a variable may depend on the values of non-financial inputs; for example variables can represent sales per employee, sales per square meter of plant, average growth over entity life, position in life cycle, etc. In another example calculation of a variable may depend on statistical relationship calculation (e.g. seasonal variation, correlation, moving averages, stochastic analysis, queuing), and use of other financial, managerial, mathematical, statistical, econometric, and other similar models and theorems and analysis tools.

In stage 432 the relationship is evaluated by an evaluator 512 using the determined values of the linked variables. Depending on the results of the evaluation and the number of paragraphs associated with the relationship, no paragraph or at least one paragraph from paragraph database 514 may be selected as appropriate for the analyzed entity by a selector 516 in stage 434. Stages 432 and 434 can be implemented, for example, by computer code including “if . . . then” statements.

For example, evaluation of a particular relationship may include comparing the magnitude of one or more of the determined values with one another. In this example, the paragraphs selected correspond to the variables with the larger (or smaller) values. Continuing with the example, the definition of this particular relationship on list 506 may be for example “compare values, select two largest” (stated in any appropriate format). In another example, evaluation of a particular relationship may include checking the magnitude of one or more of the determined values against predetermined levels (i.e. thresholds or limits) to determine which magnitudes, if any, are significant. The selected paragraph(s) will depend on which values were determined to be significant. Continuing with the example, the definition of this particular relationship on list 506 may be for example “compare value1 against threshold1, compare value2 against threshold2, characterize values above threshold as significant” (stated in any appropriate format). In another example, evaluation of a particular relationship may include verifying that all required values have been or can be determined (from available inputs) and if not determinable, omitting the selection of an associated paragraph. Continuing with the example, the definition of this relationship on list 506 may be for example “if value1 or value2 missing, relationship fail” (stated in any appropriate format). If desired, such indication can also appear at the output.

It should be evident that evaluation of a particular relationship may include more than one stage, with a different evaluation performed in each stage. For example, in one embodiment, evaluation of any relationship may include verifying that all required values have been or can be determined while evaluation of some relationships also includes other stages such as comparing magnitudes of values with one another or against predetermined levels.

Depending on the embodiment, predetermined thresholds and/or limits for values may be constant (i.e. the predetermined thresholds and/or limits for a particular relationship do not change no matter what of the entity) and/or may change depending on the entity. In one embodiment, thresholds and/or limits expressed in percents are constant whereas thresholds and/or limits expressed in a currency (for example dollar amount) are scaled depending on the entity. For example, system 500 may store dollar thresholds and/or limits for a sample entity with $100,000,000 in annual sales, and these thresholds and/or limits are scaled by dividing the actual annualized sales of the analyzed entity by $100,000,000.

In some cases, the selected paragraph(s) requires adaptation to the analyzed entity. An adapter 518, performs the adaptation in stage 435, for example by filling in one or more of the determined values of the linked variables into the selected paragraph(s). In another example, adapter 518 may call calculator 510 to calculate other values (of non-linked variables) which are required to be substituted into the selected paragraph(s) in addition to or instead of the determined linked variable values. In another example, a ranking of determined values, for example rating a financial ratio as reflecting a poor to outstanding performance, may also or instead be substituted into the selected paragraph(s). If the paragraph concerns for example a macro-economical review (say for a given country), adaptation may require filling in updated pertinent numerical figures (which are updated, say per quarter).

In stage 436 the selected and possibly adapted paragraph(s) is output through an output 520, for example to a display, printer, fax, land telephone device, cellular telephone device, transmitter TV, PDA, etc.

Preferably, the output paragraphs for all evaluated relationships are consolidated so that the paragraphs can be presented to the user in the form of a report, file, slide-show, audio-show or video etc.. It should be evident that the output paragraphs associated with each evaluated relationship does not necessarily need to be output and/or presented in the same order in which the associated relationships were evaluated. For example, in one embodiment, results of relationship evaluations which are worrisome (for example results which impact the entity's ability to continue as a going concern) may be output and/or presented first. In another example, in one embodiment, for customization reasons the order of output or presentation of paragraphs is varied, for example based on, e.g. a user profile/preference or randomly. In another example, paragraphs which are considered associated are presented next to each other, for example paragraphs related to the same item on a financial statement are presented next to each other.

Optionally, standardized paragraph(s) which do not require selection or adaptation depending on the analyzed entity may also be output in stage 436, for example, definition paragraph(s) of financial terms, etc.

Optionally system 500 also includes graphics capabilities 522 so that in addition to the output text, graphs and/or charts can be created and output in stage 438 to illustrate the evaluated relationships. For example charts of ratios, ranks and/or percentages showing comparisons with previous periods, industry averages a competitor and/or other entity may be created and output. It should be noted that the results of the evaluation of relationships can also impact the output charts and graphs (see examples below). Note, that the invention is not bound by a particular manner of outputting the data, and accordingly known per se output formats (such as: text, audio, video and or combination thereof) may be applicable in either pre-defined, or user customized manner, all as required and appropriate.

Note also that the term paragraph encompasses any adage and/or text and/or terms and/or phrase and/or expression and/or interpretive paragraph and/or interpretive text and/or assertion etc., which may also be combined with any of symbols and/or drawings and/or diagrams and/or graphs and/or animation and/or cartoons and/or means of illustration and/or means of voice/sign/code etc.

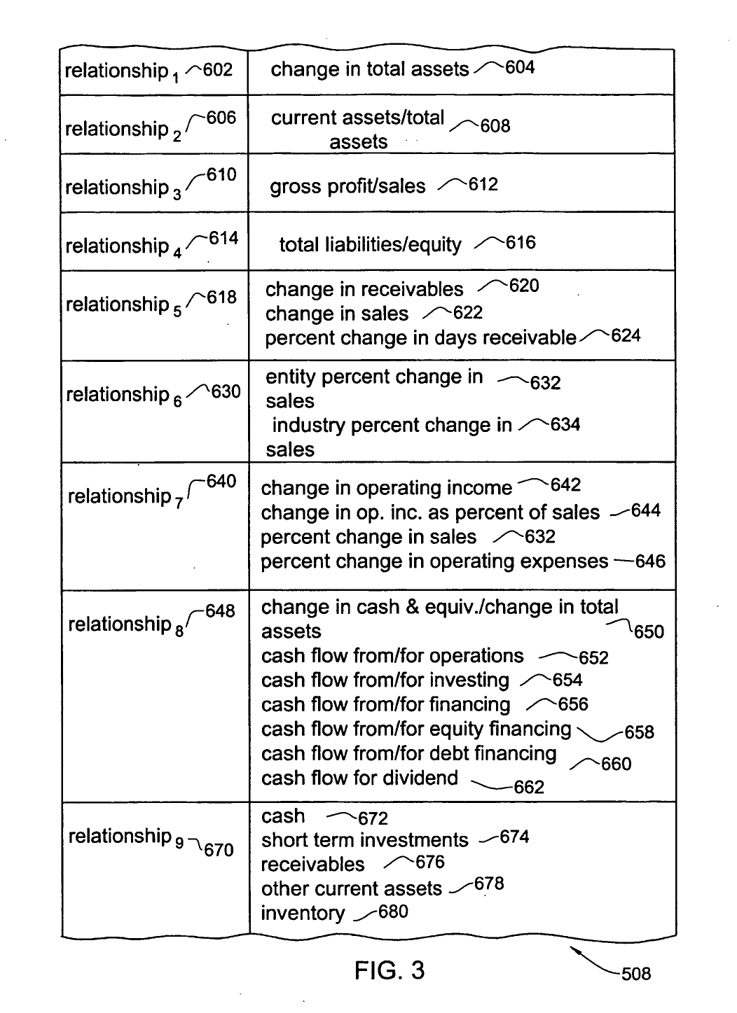

FIG. 3 shows an example of part of a look up table 508 illustrating the linked variables for a number of relationships which will be discussed below to further illustrate a preferred embodiment of the invention. It should be evident that in many embodiments, a large number of relationships are evaluated for a particular entity and that the relationships presented below should only be viewed as examples of potential relationships which can be evaluated for a given entity.

For example, a relationship₁ 602 may concern a (linked) variable 604 representing the percentage change in total assets from the period preceding the given period to the given period, (i.e. total assets at the end of the given period less total assets at the end of the preceding period divided by total assets at the end of a preceding period). For illustration purposes Appendix D presents some calculations of the values of balance sheet related variables for Impreso which are used in the examples presented herein below. In stage 430, the value of variable 502 is determined, i.e. total assets grew by 58% from Aug. 31, 2000 to Aug. 31, 2001 (calculation D702) and this has the following . . . Management/economic/business/financial bearings. In this example it is assumed that there is only one paragraph associated with relationship₁ 602. In the evaluation of relationship₁ 602 in stage 432, as long as the value of variable 604 can be determined (i.e. total assets at the end of the preceding period and at the end of the given period are received as inputs or can be computed from other inputs), then in stage 434 this associated paragraph is selected and in stage 435 adapted for the determined value. For example the paragraph output in stage 436 may be “The change in total assets from the preceding period was +58%”, where underlined characters herein below represent the adaptation of a selected paragraph by filling in value(s).

In another example a relationships 606 may concern a (linked) variable of current assets as a percentage of total assets 608. Relationship₂ 606 can be for example one of a series of relationships involving common size balance sheets and/or income statements (i.e. each item on the balance sheet as a percentage of total assets and/or each item on the income statement as a percentage of total sales), for the entity, industry and/or competitor and/or other entity. Continuing with the example, current assets as a percentage of total assets 608 is calculated to be 82% for the year ended Aug. 31, 2001 (calculation D704). Again assume only one paragraph is associated with the relationship. In the evaluation of relationship₂ 606 in stage 432, as long as the value of variable 608 can be determined (i.e. current assets as a percentage of total assets is received as an input or can be computed from other inputs), then in stage 434 this associated paragraph is selected. The associated paragraph is adapted for the computed value of variable 608. The output paragraph can state for example “Current assets represented 82% of total assets at the end of the period and this has the following . . . Management/economic/business/financial bearings”. Continuing with the example, the output paragraph can be presented for example in proximity to paragraphs stating the values of current assets as a percent of assets for the preceding period and current assets as a percent of assets for the industry and/or competitor.

In another example, a relationship₃ 610 may concern the gross profitability ratio (AKA gross margin) which equals gross profit divided by sales (linked) variable 612. For illustration purposes Appendix E presents some calculations of the values of income statement related variables for Impreso which are used in the examples presented herein below. Gross profit as a percentage of sales for Impreso is calculated at 12% (calculation E802). Assume there is one paragraph associated with relationship₃ 610. In the evaluation of relationships 610 in stage 432, as long as the value of variable 612 can be determined (i.e. gross profit divided by sales is received as an input or can be computed from other inputs), then in stage 434 this associated paragraph is selected. The associated paragraph is adapted for the value of variable 612 and output. For example the paragraph may state: “The gross margin for the entity during the period was 12% and this has the following . . . . Management/economic/business/financial bearings”. Continuing with the example, this output paragraph can be for example presented in proximity to paragraphs stating the gross margin for the preceding period and for the industry, entity and/or competitor.

In another example, relationship₄ 614 may concern a solvency ratio, liabilities divided by equity (linked) variable 616. For Impreso, total liabilities/equity equals 3.2 (calculation D708). Assume again that there is only one associated paragraph to relationship₄ 614. In the evaluation of relationship₄ 614 in stage 432, as long as the value of variable 616 can be determined (i.e. liabilities divided by equity is received as an input or can be computed from other inputs), then in stage 434 this associated paragraph is selected. In stage 435, the associated paragraph is adapted to: “The solvency ratio for the company as represented by total liabilities/equity was 3.2 at period end and this has the following . . . . Management/economic/business/financial bearings”. Continuing with the example, the associated output paragraph can for example be presented in proximity to paragraphs stating the solvency ratio for the preceding period and for the industry, other entity and/or competitor. Note that the invention is not bound by these specific examples of relationships. Note also that the term “(linked) variable”, is referred to occasionally in short as “variable”.

Optionally, system 500 may rank the value of variable 616 on an absolute basis (for example a solvency ratio over 3 may be considered high-risk in one embodiment) or may rank the value with reference to the industry, other entity, competitor and/or previous (and/or corresponding parallel) period(s). If ranking is performed, the associated paragraph may for example be adapted in stage 435 to describe and /or interpret the rank. In addition or instead, the rank for example can affect the order of output (for example if the value reflects very high risk, the paragraph may be presented early on in a report, file, slide-show, audio-show or video etc. to attract user attention), and/or the rank for example can be shown graphically in stage 438. The ranking can take into account personalized/preference user factors (received as an input). For instance, with reference to “high risk” specified above, this may be determined, depending on personalized input. Thus, what would be regarded as high risk for one user (and would entail adaptation of a paragraph, as explained above) would not be regarded as such for other user (obviously, obviating the need to invoke the specified paragraph adaptation procedure).

Note also that when reference is made to “one paragraph”, this likewise encompasses two or more substantially analogous paragraphs, in which the phrasing style is modified and /or other personalized factors are incorporated according to user preference. This allows to use one of possibly two or more different paragraphs (all having substantially the same meaning) for the same scenario, according to user preference or other paragraph selection criterion.

The next examples illustrate relationships that have more than one associated paragraph. Typically although not necessarily, relationships with more than one associated paragraph concern two or more linked variables. The determined values of the linked variables affect the selection of the associated paragraph(s) and possibly the adaptation of the selected paragraph(s). In certain embodiments, each one of the specified at least two paragraphs has no meaning by itself, however when integrated the at least two paragraphs give rise to the desired interpretation of the financial input.

For example, in stage 428 the linked variables for a relationship₅ 618 are presented in look up table 508 as: dollar change in accounts receivables from the end of the period preceding a given period to the end of the given period (variable 620), dollar change in sales from the preceding period to the given period (variable 622), and percentage change in days receivable period from the preceding period to the given period (variable 624). In stage 430, the values of the variables for Impreso are determined. Change in accounts receivables variable 620 equals $2,833,986 (calculation D712). Change in sales 622 equals $22,090,750 (calculation E808). Percentage change in days accounts receivable 624 equals +1.53% (calculation D718), where days accounts receivable is defined in the example as (365*ending accounts receivables/sales).

In stage 432, relationship₅ 618 is evaluated, where the evaluation is assumed to concern whether the values of each of variables 620, 622, and 624 represent a substantial increase, a substantial decrease or no substantial change. In this case, evaluator 512 concludes that there are substantial increases in change in accounts receivables variable 620 and change in sales variable 622 (for example because the values of variables 620 and 622 are each above a predefined threshold of $1,000,000) but no substantial percentage change in days accounts receivable variable 624 (for example because the value of variable 624 is below a predefined threshold of 5%). These conclusions influence the selection of an interpretation text in stage 434.

Refer to Appendix F which shows examples of interpretive texts associated with relationships 618 in database 514. Note that whilst Appendix F, each paragraph, say 902 is a single, self contained, paragraph this is by no means binding. Thus, in accordance with another embodiment the interpretive text 902 can be composed of two or more distinct text portions.

Bearing this in mind, for this relationships 618, the paragraphs are mutually exclusive so that only one may be selected (or none, for example if the values of all the variables could not be determined because of missing inputs). In this example, paragraph 904 is selected in stage 434 as the appropriate interpretation for the company because paragraph 904 corresponds to the case of substantial increases in accounts receivables variable 620 and sales variable 622 with a non-substantial percentage change in days accounts receivables variable 624.

Paragraph 904 requires the substitution of two values: the value of days accounts receivable in the given period and the value of days accounts receivable in the preceding period. Assuming these values have not been previously computed and stored, in stage 435 adapter 518 calls calculator 510 which computes 44.6 days (calculation D714) and 43.9 days (calculation D716) for days accounts receivable for the given period and days accounts receivable for the preceding period respectively. These values are substituted into selected paragraph 904 and adapted paragraph 904 is output in stage 436.

It should be evident that a similar relationship to relationships 618 could have been defined which is linked to percentage change variables (i.e. percent change in accounts receivables, sales, days accounts receivable) and compares these percentage change variables to predefined percent levels for significance in order to select a suitable interpretive paragraph.

In another example, relationship₆ 630 is linked to the entity percentage change in sales from the period preceding a given period to the given period (variable 632), and to the industry average percentage change in sales from the period preceding a given period to the given period (variable 634). In stage 430 the value of variables 632 for Impreso is determined to be +29.8% (calculation E824). For the sake of illustration, it is assumed that industry averages are available and that variable 634 is calculated to be +20%. In stage 432 relationships is evaluated, where the evaluation is assumed to concern whether the change in sales is significantly positive (for example above a predefined threshold of 1%), significantly negative (for example below a limit of −1%) or substantially unchanged (for example between −1% and 1%) for each of the entity and the industry.

Refer to Appendix G which shows examples of interpretive texts associated with relationship₆ 630 in database 514. In this example, paragraph 1002 is selected in stage 434 as the appropriate interpretation because paragraph 1002 corresponds to a significant increase in sales both in the industry and in the entity. Paragraph 1002 is adapted for the values of variables 632 and 634 in stage 435 and output in stage 436.

Assume now for the same relationship₆ 630 that percentage change in industry sales 634 can not be determined, for example because no industry information was input or only industry information for the given period (and not for the preceding period) was input. In stage 432, during the evaluation of the relationship the missing industry value will be realized and therefore no paragraph will be selected for output, or alternatively the user will be prompted by, e.g. “missing input parameters and therefore analysis cannot be provided”. Depending on the embodiment, the inability to select an appropriate paragraph for relationship₆ 630 may be communicated to the user (for example by outputting a list of relationships which could not be analyzed) or not (i.e. an interpretive paragraph for relationship₆ 630 will be omitted without user notification).

Similarly, in an alternative embodiment relationship₆ 630 can be linked to the entity percentage change in sales from the period preceding a given period to the given period, and to a competitor percentage change in sales from the preceding period to the given period (i.e. actual competitor(s) replacing the industry average).

In another example, assume relationship₇ 640 is linked to the dollar change in operating income from the period preceding a given period to the given period (variable 642), the change in operating income as a percent of sales from the preceding period to the given period (variable 644), the percentage change in sales from the preceding period to the given period (variable 632), and the percentage change in operating expense from the preceding period to the given period (variable 646), It is assumed that the percent change in sales 632 had been previously calculated (calculation E824) and stored in memory 504 and is now retrieved in stage 430. The values of all other variables are assumed to not have been previously computed and are therefore computed in stage 430. The values are determined to be the following: variable 642 equals $928,702 (calculation E820); variable 644 equals +0.14% (calculation E822); variable 632 equals 29.8%, and variable 646 equals +29.6% (calculation E826).

Relationship₇ 640 involves evaluating whether there are (substantial) increases or decreases for each of variables 642, 644; 632, and 646. The results of the evaluation in stage 432 is that there is a (significant) increase in operating income 642 (for example above a predefined threshold of $100,000), a similar significant percentage increase in sales 632 and operating expense 646 (for example above a predefined threshold of 5%), and an insubstantial increase in operating income as a percent of sales 644 (for example assuming a predefined system (absolute value) threshold of 1% for variable 644 to be considered substantial).

Refer to Appendix H which shows examples of interpretive texts associated with relationship₇ 640 in database. Interpretive paragraph 1122 corresponds to the case of a significant increase in operating income, a significant percentage increase in sales, a significant percentage increase in operating expense (similar to percentage increase in sales) and no significant change in operating income as a percent of sales. Therefore paragraph 1122 is selected in stage 434.

Paragraph 1122 is adapted by determining and filling in values for operating income for the given period $3,583,774 (calculation E828), operating income for the preceding period $2,655,022 (calculation E830), operating income as a percentage of sales 3.7% for the given period (calculation E832). In addition the determined value (+29.8%) of linked variable percentage change in sales 632 is filled in.

In another example, relationships 648 is linked to the change in cash and cash equivalents from the period preceding a given period to the given period as a percentage of the change in total assets from the preceding period to the given period 650, cash flow from/for operating activities 652, cash flow from/for investing activities 654, cash flow from/for financing activities 656 and variables for types of financing activities, namely cash flow from/for stock activities 658, cash flow from/for debt activities 660, and cash flow for payment of dividend 662. For illustration purposes Appendix I presents some calculations of the values of cash flow statement related variables for Impreso which are used in the examples presented herein below. In stage 430 the value of variables 650,652,654,656,658, 660 and 662 are determined to be is determined to be 0.27% (calculation D720), $5,138,552 (calculation I1202), −$13,734,574 (calculation 11204), $8,658,027 (calculation I1206), −$38,892 (calculation 11208), $8,696,919 (calculation 11210), and zero (no dividend), respectively.

In stage 432, for the evaluation of relationship₈ a two stage comparison is made. In the first stage, the change in cash and equivalents as a percent of the change in total assets 650 is evaluated to be significantly positive, significantly negative or substantially unchanged. For example, the (absolute value) threshold may be set at 5% with any change 650 above 5% or below −5% considered significant. In the second stage which occurs if the conclusion of the first stage was that there was a significantly positive or negative change in cash and cash equivalents 650, the magnitudes of variables 652,654,656,658, 660 and 662 are compared to determine the most significant contributory factor(s) to the change. An appropriate interpretive paragraph is then selected in stage 434.

Refer to Appendix J which shows examples of interpretive texts associated with relationships in database 514. In this example the change in cash and equivalents 650 is considered insignificant so paragraph 1320 is selected. Paragraph 1320 is adapted by filling in values of ending cash and equivalents for the preceding period and for the given period, $149,527 (calculation D722) and $211,352 (calculation D724) respectively, and the Management/economic/business/financial meaning of these values is provided.

In some cases evaluation of the relationship in stage 432 may lead to the selection of more than one interpretative text which is associated with the relationship For example, relationships 670 evaluates the relationship between different types of current assets. Variables linked to relationship₈ 670 include cash 672, short term investments 674, accounts receivable 676, other current assets 678, and inventory 680. In stage 430, the values of the linked variables are determined as cash 672 equals $211,352 (calculation D724), short term investments 674 equals zero, accounts receivable 676 equals $11,748,088 (calculation D726), other current assets 678 (here prepaid plus deferred taxes) equals $350,956 (calculation D728), and inventory 680 equals $38,459,817 (calculation D730). The evaluation of relationships 670 is in order to choose the variables with the two largest values among variables 672,674,676,678 and 680. Here inventory 680 and accounts receivable 676 are chosen.

Refer to Appendix K which shows examples of interpretive texts associated with relationships in database 514. In stage 434, paragraphs 1406 and 1410 corresponding to accounts receivable and inventory respectively (i.e. the two largest values) are selected. Paragraph 1406 is adapted by filling in the values of accounts receivable and accounts receivable as a percent of current assets (and the meaning of this values) and paragraph 1410 is adapted by filling in the values of inventory and inventory as a percent of current assets (and the meaning of this values). It should be noted that the results of the evaluation of relationships (and the meaning of this relationship) can also impact output charts and graphs. For example a graph showing the breakdown in current assets may use the evaluation results of relationships to group together categories, keeping the two largest categories, here inventory and accounts receivable, as separate categories and grouping together all other current asset categories.

Note that the output paragraph(s), or portion thereof, may be associated with an alert indication (referred to also as “red flag”) according to the significant degree of the their contents. For example, if a certain paragraph (or, say, a value incorporated in the output paragraph) indicates on a negative interpretation, an alert is provided for drawing the reader's attention. This alert may be implemented by various means, such as placing the pertinent paragraph(s) at the top of the output report, highlighting the specified paragraph(s) and/or providing any other desired alert means. This, likewise, applies to the event that positive interpretation is reported.

Note also, that for convenience, the system (e.g. of the kind depicted with reference to FIG. 2) can be associated with search means for facilitating fast text (and/or other digits/symbols and other search items) search, e.g. in the output paragraph(s) report.

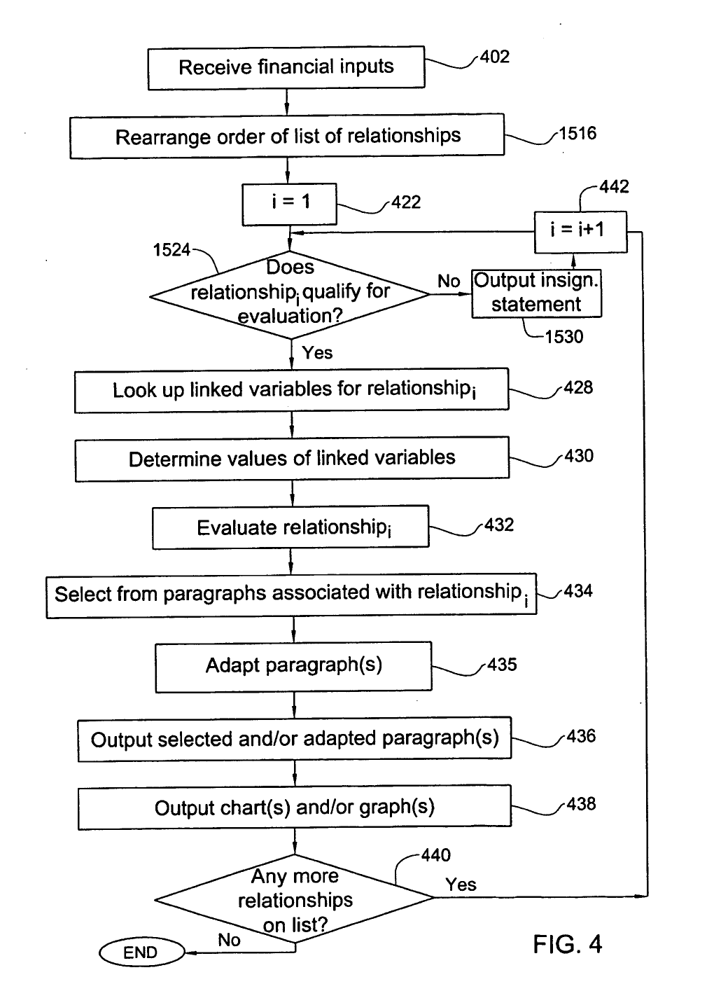

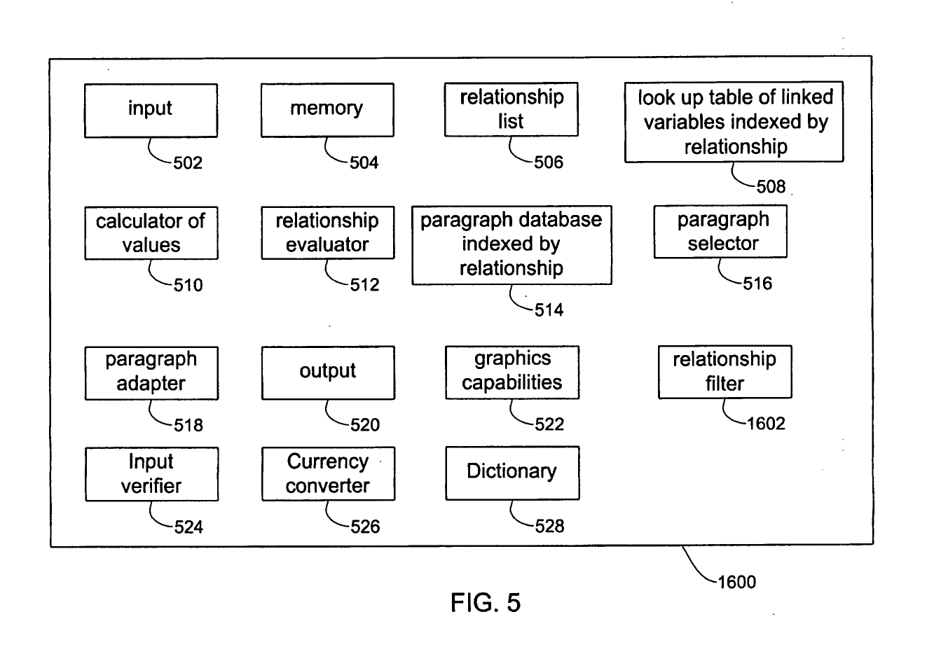

The method of another preferred embodiment is illustrated in FIG. 4. An electronic system 1600 for implementing the method of FIG. 4 is shown in FIG. 5. System 1600 can be made up of any combination of software, hardware and/or firmware. For example, system 1600 can be inter-alia a computer, a land telephone device, a cellular telephone device, a personal digital assistant PDA, a software program, a programmable chip, etc. The division into modules shown in FIG. 5 are for ease of understanding and in other embodiments a module may be separated into a plurality of modules or alternatively combined with other modules. System 1600 may is be located at a user location, for example on a user personal computer, cellular telephone or system 1600 may be located remotely from a user, for example on a web server with which the user communicates via the Internet or any other remote means.

Only the differences in the method and system compared to the method and system of FIGS. 1 and 2 will be discussed below.

In optional stage 1516, a filter 1602 rearranges the order of evaluation of relationships, if desired. For example a user may prefer to have relationships relating to the income statement evaluated first or, for instance, in certain cases evaluated exclusively (i.e. no other relationship is to be evaluated). Therefore, referring back to FIG. 3, relationship₃ 610 would be evaluated for example before relationship₁ 602. A user may enter his or her preferences into input 502 through any known method, for example, pull down menu selection, keyboard entering, voice recognition and analysis system, etc.

In stage 1524, the relationship is filtered by filter 1602 to determine if evaluation is desirable. If evaluation is not desirable, the relationship is excluded from evaluation. Otherwise the method continues with stage 428

The criteria used by filter 1602 in stage 1524 to determine if evaluation is desirable for a particular relationship can be user-dependent and/or entity dependent.

For example, the user may have already calculated ratios and may not wish to receive output paragraphs describing those ratios. In another example, a user may only wish to have relationships evaluated which link variables relating to industry averages with variables relating to the entity. In another example, the user may wish to only have relationships evaluated which link income statement variables. In another example, the user may only wish to evaluate relationships which are linked to certain specified variables. In another example, a user may wish to omit evaluation of relationships which are linked to certain specified variables. In another example one user may wish to receive a short analysis (i.e. evaluation of a limited number of relationships), whereas another user may wish to receive an extensive analysis (i.e. evaluation of a large number of relationships). In another example, a user may wish to receive parts of the analysis at different times (i.e. have the evaluation of different sets of relationships performed at different times). The user can input filtering criteria into input 502 in any known manner, for example pull down menu selection, keyboard entering, voice recognition and analysis systems etc.

Examples of entity dependent filtering include significance tests. For example, evaluation of a relationship may only be desirable if one or more variables are significant for the analyzed entity. The variables tested for significance for a particular relationship may in some cases only include one or more of the variables which are linked in the relationship (i.e. whose values are required to evaluate the relationship). In other cases the tested variables for a particular relationship may include variables which are not linked in the relationship. Significance can be relative (i.e. a variable is significant if the value of the variable is large or small compared to certain other variables) or absolute (i.e. a variable is significant if the value of the variable is smaller or larger than a predetermined level, where the predetermined level may be constant or may change depending on the entity, and/or industry and or other entities-see above). In certain cases, the filtering may apply rules depending upon criterion such as the business of the entity. For example, for public service related entity there is no need to take into account relationships which concern inventory, whereas for entity that deals with manufacture relationships which concern inventory are definitely relevant.

In a preferred embodiment, some relationships always qualify for evaluation (if not filtered out by the user) while others have one or more associated significance tests performed in order to determine if the relationship should be evaluated.

For example, the method of FIG. 4 can be applied to relationship₁ 602, linked to change in total assets variable 604. Assume in this example that relationship 602 does not have any significance tests because relationship 602 is considered inherently desirable and therefore will always be evaluated, if not eliminated by user filtering. No entity dependent filter would therefore be applied in stage 524 for this relationship in this example.

For another example, apply the significance testing to relationship₅ 618 relating to accounts receivables. Assume that in stage 524, a three part significance test is applied by filter 1602 (preferably in sequence). First that current assets be a significant part of total assets (for example above a predetermined threshold percentage or sum), second that accounts receivables be a significant part of current assets (for example one of two largest current asset categories) and third that the value of the change in accounts receivables 620 is significant (for example above a predetermined percentage and/or dollar amount). For Impreso, current assets was determined to be a significant part of total assets (82% of total assets-see above discussion of relationship₂ 606), and the two most significant current assets had included accounts receivables D726 (see above discussion of relationships 670) Note that the first two parts of the tests can use results of relationship₂ 606 and relationship₉ 670 and therefore in this embodiment, relationship₉ 670 and relationship₂ 606 would preferably have been evaluated before applying the significance test for relationship₅ 618. The third part of the significance test involves one of the linked variables for relationship₅ 618, namely change in accounts receivables 620 which is determined to be significant at $2,833,986 (calculation D712). In this example, the significance test is passed and therefore the method proceeds with stage 428 for relationships 618 (see above).

For another example, apply the significance testing to relationship₆ 630 comparing the entity and the industry (or competitor and/or other entity). Assume that in stage 1524, a two part significance test is applied involving the two linked variables 632 and 634. Either the percentage change in sales for the entity or the percentage change in sales for the industry, other entity (or competitor) needs to be significant (for example above a certain percentage change threshold). In this example both are determined to be significant, the test is passed and the method proceeds with stage 428 for relationship₆ 630 (as described above).

For another example, apply the significance testing to relationship₉ 670 involving types of current assets. Assume that in stage 1524, it is determined if current assets as a percentage of total assets is significant. Because the value of current assets as a percentage of total assets is determined to be significant, the method proceeds with stage 428 for relationship₉ 670 (see above).

For another example, apply the significance testing to relationship₈ 648. In this embodiment relationships can be modified to exclude change in cash and cash equivalents as a percent of the change in total assets 650 as a linked variable. Instead the value of change in cash and cash equivalents as a percentage of the change in total assets is tested for significance in stage 1524. At a value of 0.27%, the change is determined to be insignificant and therefore relationship₈ is not evaluated, giving rise to appropriate output paragraph (indicating that no significant change has been encountered), or providing no output). Note that had the change been significant, the evaluation of relationships would only need involve the second stage of the two comparison stages described above for the embodiment of FIG. 1, i.e. the comparison of the magnitudes of variables 652,654,656,658, 660 and 662 to determine the most significant contributory factor(s) to the change in cash and equivalents.

When a significance test fails, system 1600 may output a statement of insignificance in optional stage 1530. For example in the case of relationships 648, the statement may say “The change in cash and cash equivalents as a percentage of the change in total assets of 0.27% is considered immaterial and will therefore not be discussed”, where the tested variable, change in cash and cash equivalents as a percentage of change in total assets, and the value of the variable are inserted into a standard statement. Alternatively, system 1600 proceeds to analyze the next relationship without commenting on the failure of the previous relationship to pass the test of significance. If the significance test shows that it is insignificant for a given period, but that for another period it is significant, then an appropriate output statement is provided.

Embodiments of the current invention may be used inter-alia by managers and salaried employees, entity directors, entity owners, potential investors, bankers and credit officers, economists and analysts, brokers and appraisers, accountants, attorneys, journalists, tax authorities, financial information agencies, business information companies, financial websites, financial periodicals, risk capital funds, analyst companies, investment banks, insurance companies, rating companies, financial advisors, credit rating companies, venture capital funds, government institutes, stock exchange, lecturers, students, etc.

Embodiments of the current invention may be used inter-alia for daily managerial control over current operations, assistance prior to audit, credit check by bankers before granting credit, daily control by banks and suppliers with respect to financial liquidity and stability, supplier and client check prior to contract negotiations, shareholders' monitoring of operations, risk assessment, check by investors, shareholders and analysts on results vis-a-vis share activities, due diligence, entity valuation, viability analysis (going concern), check by investors prior to investing, supplementary information for checking sound investments, Provision or interpretation of forecasts, breakeven point analysis, investments analysis, required working capital analysis, analysis of expected cash flow, provision or interpretation of budget, actual versus planed budget comparison and/or analysis, inventory analysis, segmentation analysis, risk analysis, evaluations of entities or activities, evaluations of securities and of debts, sensitivity analysis, etc.; supplementary value assessment, preparation for meetings on entity (by shareholders, managers, directors, etc), assistance in preparing management discussion and analysis, supplementary information on investment profitability, profitability assessment and dividend payment to shareholders, analysis and surveys by journalists, supplementary information by attorneys, enhancement of business practices, managerial practices, monitoring municipal and government entities, etc.

The advantages of certain embodiments of the current invention include one or more of the following, inter-alia: First, a full scale analysis or a tailored analysis of an entity can be provided depending on whether the filtering feature is used. Second, the analysis is performed in an unbiased manner. Third, the analysis is preferably executed efficiently and comprehensively, with less likelihood of oversight of important observations. Fourth, the output paragraphs provide a user-friendly interpretation to the financial state of the analyzed entity. Fifth, the analysis may be performed quickly and conveniently when needed, preferably available 24 hours a day and 365 days a year. Sixth, the analysis may be customized to different industries and/or countries and/or languages and/or currencies. Seventh, the analysis can be carried out simultaneously on a large number of entities.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

| | Aug. 31, 2001 | Aug. 31, 2000 |
|---|---|---|
| Current assets: | | |
| Cash and cash equivalents | $211,352 | $149,527 |
| Trade accounts receivable, net of allowance | 11,748,088 | 8,914,102 |
| for doubtful accounts of $342,780 at Aug. 31, 2001 | | |
| and $168,631 at Aug. 31, 2000 | | |
| Inventories | 38,459,817 | 21,232,863 |
| Prepaid expenses and other | 234,411 | 234,201 |
| Deferred income tax assets | 116,545 | 57,335 |
| Total current assets | 50,770,213 | 30,588,028 |
| Property, plant and equipment, at cost | 21,725,088 | 18,648,715 |
| Less-Accumulate depreciation | (10,511,892) | (9,880,019) |
| Net property, plant and equipment | 11,213,196 | 8,768,696 |
| Other assets | 219,188 | 26,824 |
| Total assets | $62,202,597 | $39,383,548 |
| Current liabilities | | |
| Accounts payable | $18,572,200 | $6,623,776 |
| Accrued liabilities | 1,942,241 | 1,984,952 |
| Current maturities of long-term debt | 1,404,562 | 247,798 |
| Line of credit | 18,308,338 | 12,469,390 |
| Current maturities of prepetition debt | 7,484 | 7,194 |
| Total current liabilities | 40,234,825 | 21,333,110 |
| Deferred income tax liability | 926,675 | 763,769 |
| Long-term debt, net of current maturities | 6,083,279 | 3,529,352 |
| Long-term portion of prepetition debt, net of current maturities | 245,175 | 252,727 |
| Total liabilities | 47,489,954 | 25,878,958 |
| Commitments and contingencies | | |
| Stockholders' equity: | | |
| Preferred stock, $.01 par value; 5,000,000 shares authorized; 0 shares | | |
| Issued and outstanding | — | — |
| Common stock, $.01 par value; 15,000,000 shares authorized; | 52,928 | 52,928 |
| 5,292,780 issued and 5,278,780 outstanding at Aug. 31, 2001; | | |
| 5,292,780 issued and outstanding at Aug. 31, 2000; | | |
| Warrants | — | 110 |
| Treasury stock (14,000 shares, at cost) | (38,892) | — |
| Additional paid-in capital | 6,319,682 | 6,319,572 |
| Retained earning | 8,378,925 | 7,131,980 |
| Total stockholders' equity | 14,712,643 | 13,504,590 |
| Total liabilities and stockholders' equity | $62,202,597 | $39,383,548 |

| | Years Ended August 31, | | |
|---|---|---|---|
| | 2001 | 2000 | 1999 |
| Net sales | $96,208,411 | $74,117,661 | $61,506,207 |
| Cost of sales | 84,752,004 | 64,624,852 | 53,844,953 |
| Gross profit | 11,456,407 | 9,492,809 | 7,661,254 |
| Other costs | | | |
| and expenses: | | | |
| Selling, general and | 7,872,633 | 6,837,737 | 5,605,959 |
| administrative | | | |
| Interest expense | 1,632,581 | 1,304,369 | 832,539 |
| Other income, net | (72,259) | (137,791) | (41,971) |
| Total other costs | 9,432,955 | 8,004,315 | 6,396,527 |
| and expenses | | | |
| Income before income | 2,023,452 | 1,488,494 | 1,264,727 |
| tax expense | | | |
| Income tax expense: | | | |
| Current | 725,560 | 534,273 | 478,390 |
| Deferred | 50,947 | 22,904 | 11,985 |
| Total income | 776,507 | 557,177 | 490,375 |
| tax expense | | | |
| Net income | $1,246,945 | $931,317 | $774,352 |
| Net income per share | $.24 | $0.18 | $0.15 |
| (basic and diluted) | | | |
| Weighted average | 5,281,583 | 5,292,780 | 5,292,780 |
| shares outstanding | | | |

| | Years Ended August 31, | | |
|---|---|---|---|
| | 2001 | 2000 | 1999 |
| Cash flows from operating activities: | $1,246,945 | $931,317 | $774,352 |
| Net income | | | |
| Adjustments to reconcile net income to net | | | |
| Cash used in operating activities - | | | |
| Depreciation and amortization | 873,976 | 688,698 | 544,828 |
| Loss (Gain) on sale of property, plant and equipment | 20,062 | (17,019) | (3,901) |
| Deferred income taxes | 103,696 | 22,904 | 58,648 |
| Decrease (increase) in trade accounts receivable, net | 1,247,458 | (2,618,114) | (61,983) |
| Decrease in income tax receivable | — | 478,909 | 420 |
| Increase in inventory | (8,192,323) | (2,431,848) | (9,611,042) |
| (Increase) decrease in prepaid expenses and other | 54,210 | (22,374) | 93,851 |
| Increase (decrease) in accounts payable | 10,407,363 | (2,430,131) | 7,474,969 |
| (Decrease) increase in accrued liabilities | (622,835) | 306,090 | 630,414 |
| Net cash provided by (used in) operating activities | 5,138,552 | (5,091,568) | (99,444) |
| Cash flows from investing Activities: | | | |
| Additions to property, plant and equipment | (1,200,101) | (2,296,553) | (657,735) |
| Proceeds from sale of property, plant and equipment | 14,742 | 66,400 | 6,842 |
| Acquisition of sky assets | (12,357,031) | — | — |
| Change in other assets | (192,364) | (7,371) | 8,812 |
| Net cash used in investing activities | (13,734,754) | (2,230,153) | (650,893) |
| Cash flows from Financing Activities: | | | |
| Net borrowing on line of credit | 5,838,948 | 6,111,603 | 755,186 |
| Payments on prepetition debt | (7,262) | (660,097) | (74,439) |
| Net borrowing (payments) on post-petition debt | 2,865,233 | 2,004,484 | (34,433) |
| Purchase of Treasury Stock | (38,892) | — | — |
| Net cash provided by financing activities | 8,658,027 | 7,455,990 | 646,314 |
| Net increase (decrease) in cash and cash equivalents | 61,825 | 134,269 | (104,023) |
| Cash and cash equivalents, beginning of year | 149,527 | 22,629 | 117,840 |
| Cash and cash equivalents, end of year | $211,351 | $156,898 | $13,817 |

APPENDIX D

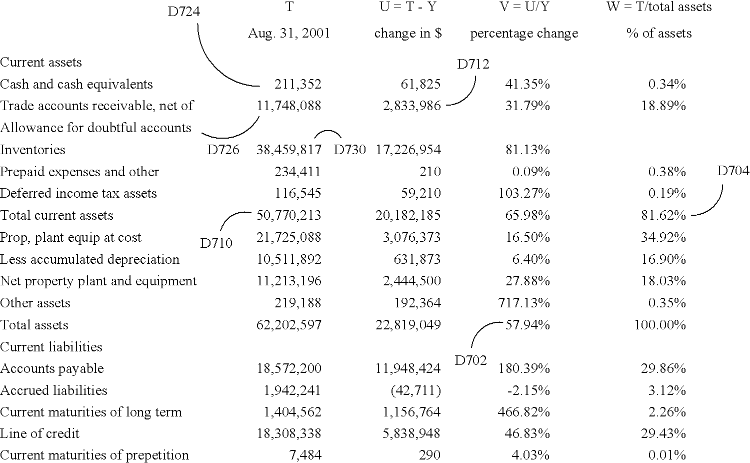

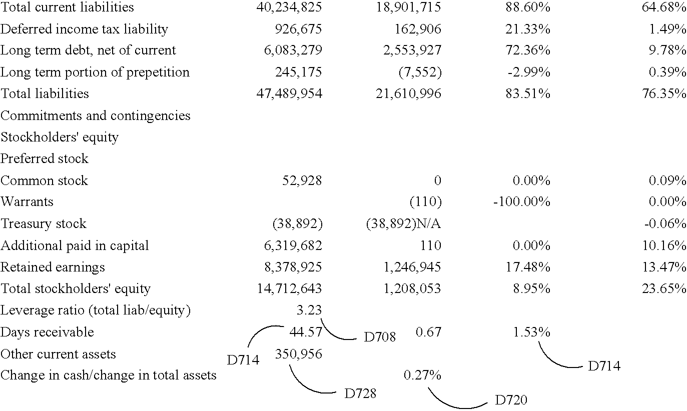

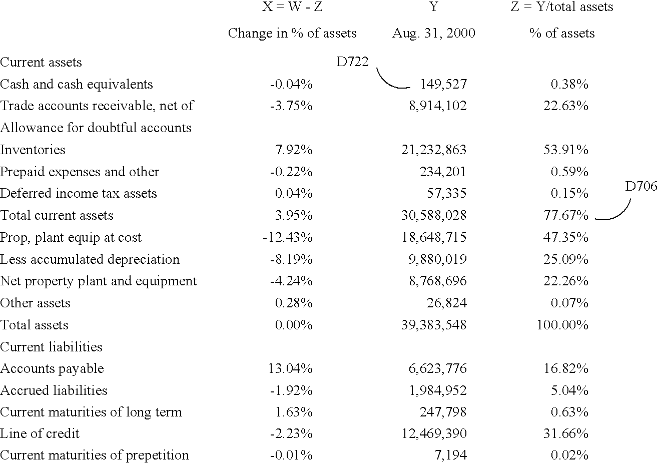

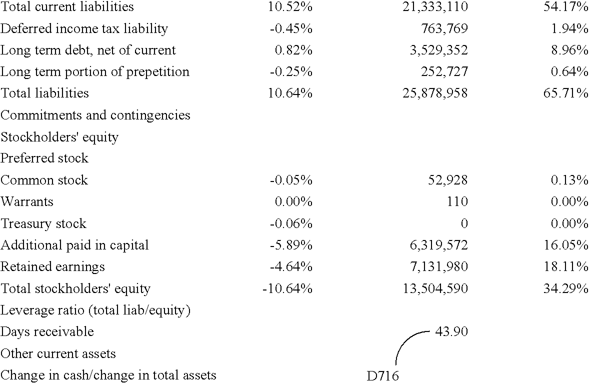

APPENDIX E

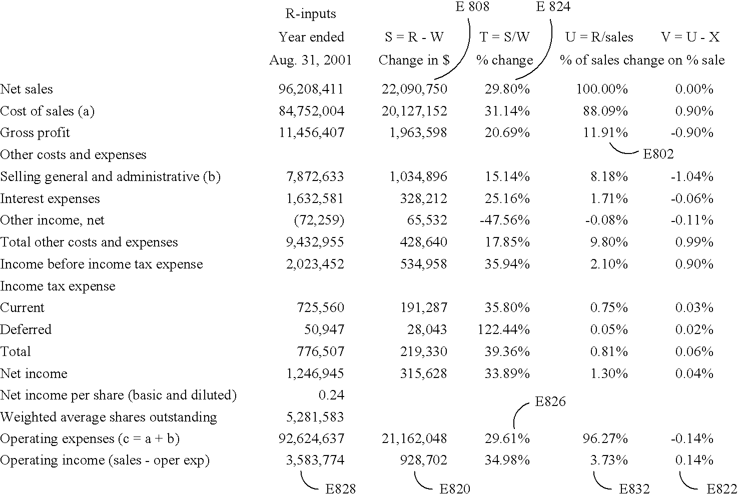

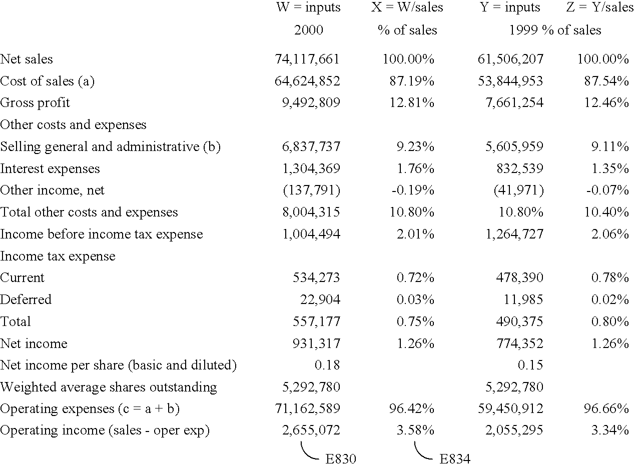

### APPENDIX F

902

The main growth in accounts receivable as appears in the current financial statements is attributed to growth in operations, reflected in sales growth. This has immediate short-term ramifications in growth in cash flow. In the intermediate and long term, should this trend continue, there will be a potential for business expansion, for increasing total operations and for improving cash flow and profitability. It is worth emphasizing that the growth in accounts receivable is not a result of enhanced credit terms granted to customers in increasing credit days, but is rather attributed entirely to the growth in sales and the expansion of total credit as a result of the growth in sales. This can be clearly seen by the fact that the average number of credit days granted to customers in the period of the financial statements is ______ credit days, as compared to an average of ______ credit days during the previous period (a . . . % decline ). Hence, we consider this state of affairs a positive and desirable one, attesting to the potential for expansion and growth in activity. Should these circumstances continue, we will be seeing improved cash flow and profitability both in the short and long terms.

904

The increase in accounts receivable as appears in the current financial statements is attributed to growth in operations, reflected in sales growth. This has immediate short-term ramifications of growth in cash flow. Should this trend persist also in future, both in the medium and long term, this will be a potential for business expansion, an increase in total operations and improvement in cash flow and profitability. It is worthwhile emphasizing that the growth in accounts receivable is not a result of enhanced credit terms granted to customers in increasing credit days, but is rather completely attributed to the growth in sales and the expansion of total credit as a result of the growth in sales. This can be seen clearly by the fact that the average number of credit days granted to customers in the period of the financial statements is ______ credit days, similar to the previous period. Hence, we consider this state of affairs a positive and desirable one, attesting to the potential for expansion and growth in activity. Should these circumstances continue, this will lead to improvement in cash flow and in profitability both in the short and long terms.

906

The growth in accounts receivable appearing in the current financial statements, appears to have direct ramifications on growth in the sales item. In other words, one can conclude, that the increased credit granted to customers appears to be the main reason for the higher sales. This marketing strategy is reflected in improvement and in the extension of credit granted to customers, leading to growth in sales. Such a marketing strategy has short-term positive ramifications that will be reflected in growth in cash flow and also in the potential of business expansion and in forecasted growth of total operations. As a result, should this trend continue, improvement in profitability is expected.

Nevertheless, it is worthwhile noting that these circumstances of extended credit in the form of increased credit to customers, obviously entails an economic price reflected in financing expenses and harm to profitability. Accordingly, if we examine and analyze the overall picture, it can be stated that in the long term, the marketing strategy of increased credit to customers, followed by an increase in the sales item, has potential for growth in profitability and cash flow, but in the short term the price of such growth is higher financing expenses, harm to cash flow and a decline in profitability.

908

The extended credit granted to customers as appears in the current financial statements, comes at a time of also stability in sales, and therefore is mainly attributed to a delay in collections. These circumstances may be regarded as negative, attesting to difficulties and slower operations and/or more intense competition and the desire to maintain market share. The granting of extended credit to customers obviously entails an economic price in the form of financing expenses. This is a negative phenomenon and its short-term ramifications will be expressed in a decline in cash flow in addition to the decline in profitability, attesting to difficulties in operations as reflected in the sales item, as well as in customer collections.

It is possible that the slower collections of customer debt can be attributed to difficulties faced by the customers themselves. Such a situation clearly arouses concern, both with respect to the collection of past debts, and certainly with regard to the future business relations with these customers and the potential sales as a result.

However if the extended credit to customers is part of a marketing effort, in an attempt to encourage and increase total sales in future, this definitely possesses potential for business expansion and for growth in total operations.

In conclusion, an overall observation of the data of slower collections together with stability in sales, or in other words—higher customer credit not supported by growth in the sales item—is negative and undesirable, attesting to potential harm to profitability and to cash flow.

910

The extended credit granted to customers as appears in the current financial statements, comes at a time when there is also a reduction in sales, and therefore is attributed mostly to the delay in collections. These circumstances should be viewed as negative, attesting to difficulties and slower operations and/or more intense competition and the desire to maintain market share. The granting of extended credit to customers obviously entails an economic price in the form of financing expenses. This is a negative situation and its short-term ramifications will be expressed in a decline in cash flow in addition to the decline in profitability, attesting to difficulties in operations as reflected in the sales item, as well as in customer collections.

It is possible that the slower collections of customer debt can be attributed to difficulties faced by the customers themselves. Such a situation clearly arouses concern, both with respect to the collection of past debts, and certainly with regard to the future business relations with these customers and the potential sales as a result.

However if the extended credit to customers is a marketing effort, in an attempt to encourage and increase total sales in future, this definitely possesses potential for business expansion and for growth in total operations.

In conclusion, an overall observation of the data of slower collections together with a decline in sales, or in other words—higher customer credit not supported by growth in the sales item—is a negative and undesirable situation, attesting to potential harm to profitability and to cash flow.

912

The decline in accounts receivable as appears in the current financial statements is attributed to a weakening of activity, reflected in lower sales. This has immediate short-term ramifications on a reduction in cash flow. In the intermediate and long term, should this trend persist, there is the potential for a standstill in business activity, which will adversely affect cash flow and profitability. An additional point worth noting is that the decline in accounts receivable (total credit) comes at a time when credit terms are also deteriorating, reflected in the contraction of the number of days of credit. This may likely be the main reason for the reduced sales, since a deterioration in customer credit terms, generally leads to a loss of customer motivation and in an extreme case, even the defection of customers to the competitors. This is certainly an undesirable situation, with the potential of contraction in overall activities and may very well hamper the corporation's cash flow and profitability in both the short and long terms.

914

The decrease in accounts receivable as appears in the current financial statements, is attributed to a contraction in operations as reflected in reduced sales. This phenomenon has immediate short-term ramifications in a reduction of cash flow. Should this trend persist also in future, both in the medium and long term, this has the potential for a slowdown and contraction in business activity, a decline in total operations and a deterioration in cash flow and profitability. It is worthwhile emphasizing that the contraction in accounts receivable is not a result of a deterioration in credit terms granted to customers by reducing credit days, but rather this is attributed entirely to the reduction in total sales and the contraction in total credit as a result of the lower sales. This can clearly be seen by the fact that the average number of credit days granted to customers in the period of the financial statements is ______ credit days, as compared to an average of ______ credit days during the previous period. Hence, we consider this state of affairs a negative and undesirable one, attesting to a potential for contraction and slowdown in activity. Should these circumstances continue, this will lead to a deterioration in cash flow and profitability both in the short and long terms.

916

The reduction in accounts receivable as appears in the current financial statements, is affected by the lower sales and in parallel also influences this decline. Measures that would be called for, in the company's attempt to increase sales, would be to improve customer credit by extending credit days in order to encourage customers to increase purchases. The average number of customer credit days during the period of the statements indeed grew and stands at ______ credit days as compared to an average of . . . credit days during the previous period ( . . . % growth). This is a marketing strategy with negative ramifications on financing expenses and profitability in the short term. Any growth in customer credit requires the search of financing sources and these naturally have a cost, by increasing financing expenses in the income statement. Nevertheless, one should not ignore the objective behind such a move. The intention of the extended customer credit is to eventually increase sales to a considerable extent and that growth in sales will be significantly higher than the growth in financing expenses.

Therefore, if we examine and analyze the overall picture in the near term, there is the growth in financing expenses and as result harm to profitability and cash flow, versus the target of sales growth with enhanced profitability and cash flow in the longer term.

918

The contraction in credit as appears in the current financial statements comes at a time of stability in sales, revealing that the reason for the contraction in credit is mainly attributed to accelerated debt collection. This should be viewed as positive circumstances, attesting to successes in the debt collection activity. The reduced credit to customers has, of course, an economic advantage in the form of savings in financing expenses. This is a positive state of affairs, with positive ramifications in the short term of growth in cash flow, in addition to higher profitability.

It may well be that the acceleration of debt collection reflects the positive development at the customers. This is undoubtedly a promising situation in terms of the collection of past debts and certainly in terms of the continued business ties with these customers as well as the potential for future sales. If the reduction in credit to customers has been made for financing reasons in an attempt to minimize total financing expenses at a later date, this also has a potential for profitability.

In conclusion, an overall examination of the data of accelerated debt collection together with stability in sales or, in other words—reduced credit to customers which is not supported by higher sales—is, on the one hand, a positive dimension of management's ability to increase debt collection but, on the other hand, demonstrates inferior sales and business operations.

920

The contraction in credit as appears in the current financial statements comes at a time of growth in sales, demonstrating that the reason is mainly attributed to accelerated debt collection. This is a positive state of affairs, attesting to successful and accelerated business operations. The granting of reduced credit to customers has, of course, an economic advantage in the form of savings in financing expenses. This is a positive state of affairs, whose positive ramifications in the short term are growth in cash flow, in addition to higher profitability. The above attests to successful business operations reflected in the sales item, as well as in customer debt collection.

It may well be that the acceleration of debt collection reflects positive developments at the customers. This is undoubtedly a promising situation in terms of the collection of past debts and certainly in terms of the continued business ties with these customers as well as the potential for sales as a result. If the reduction in credit to customers was made for financing reasons in an attempt to minimize total financing expenses in the future, this also has a potential for profitability.

In conclusion, an overall examination of the data of accelerated debt collection together with growth in sales or, in other words—reduced credit to customers supported by higher sales—is a positive dimension of management's ability to increase debt collection resulting in enhanced profitability and cash flow.

922

Accounts receivable in the current financial statements remains essentially unchanged in relation to the previous period, despite the increased activity, as reflected in sales growth. This demonstrates that measures have been taken to reduce credit to customers, which has positive ramifications on cash flow and profitability. This is also reflected in the reduction of customer credit days. This is a very desirable situation and may be attributed to one or more of the following reasons:
Growth was exhibited in sales without the need to increase credit to customers.
The customers have no liquidity problems.
   924

In the current financial statements, the accounts receivable item remained essentially unchanged as compared to the previous period, despite the decline in sales. Such a situation is undesirable and can be attributed to one or more of the following reasons:
Extended credit to customers, in order to reduce the constant decline in sales.
Difficulties faced by customers, causing a delay in debt collection.
A time lag which was created between the decline in sales and actual debt collection, since credit was granted to customers in the previous period, prior to the decline sales.

The practical significance of lower sales, on the one hand, and accounts receivable remaining materially unchanged on the other, is that of higher credit granted to customers. This credit, as mentioned earlier entails an economic price in the form of financing expenses. The growth in credit together with the decline in total sales is a negative situation attesting to difficulties and a slowdown in operations. The short-term ramifications will be a fall in cash flow in addition, of course, to lower profitability. A comprehensive view shows that the data attest to difficulties in marketing activity.

If the slow-down in customer debt collection is attributed to difficulties faced by the customers, this should raise concerns regarding the collection of past debts, and certainly with respect to the continued business ties with these customers and the potential sales as a result. However, if the extended credit to customers is a marketing strategy, aiming to encourage and increase future sales, this indeed holds the potential for expansion in business operations and total activity.

926

In the current financial statements, the accounts receivable item remains essentially unchanged relative to the previous period, at a time when the sales item also remains essentially unchanged as compared to the previous period. These facts are obviously reflected in the average number of credit days extended to customers which during the period of the financial statements stood at ______ credit days. In other words, no essential change. The data demonstrates stability in marketing activity, and therefore the question is why isn't there growth in sales? A state of stability often has advantages in various market conditions, but it may lead to a downturn in business activity and eventually to recession.

A state of stability in sales and in customer credit requires caution and supervision over business results in the subsequent quarters, in order to ascertain whether this is only a temporary state or whether the signals show the beginning of a downturn in business activity.

### APPENDIX G

1002

Similarly to the trend in the industry, the sales in the Financial Statements is also rising relative to the previous period. The average growth in the industry between the two periods is ______% compared with an increase in sales of ______% in the present Financial Statements.

1004

Similarly to the trend in the industry, the sales in the Financial Statements is also decreasing in relation to the previous period. The average decline in the industry between the two periods is ______%, compared with a drop in sales of ______% in the present Financial Statements.

1006

Similarly to the trend in the industry, the sales in the Financial Statements also remains without material change relative to the sales in the previous period.

1008

Contrary to the figures in the Financial Statements, the average sales in the industry showed a rising trend relative to the previous period. The average increase in the industry was at the rate of ______%, compared to the drop in sales at the rate of ______% in the Financial Statements before us.

1010

Contrary to the figures in the present Financial Statements, the average sales in the industry showed a declining trend relative to the previous period. The average drop in the industry was at the rate of ______%, compared to the rise in sales at the rate of ______% in the Financial Statements.

1012

Contrary to the figures in the Financial Statements, the average sales in the industry is stable and remains with no material change relative to the previous period, compared to the decline in sales at the rate of ______% in the Financial Statements before us.

1014

Contrary to the figures in the Financial Statements, the average sales in the industry show a rising trend relative to the previous period. The average increase in the industry is at the rate of ______%, compared to the stability and no material change in sales in the Financial Statements.

1016

Contrary to the figures in the Financial Statements, the average sales in the industry show a declining trend relative to the previous period. The average decrease in the industry is at the rate of ______%, compared to the stability and no material change in sales in the Financial Statements.

Contrary to the figures in the Financial Statements, the average sales in the industry is stable and remains with no material change relative to the previous period, compared to the rise in sales at the rate of ______% in the Financial Statements.

### APPENDIX H

1102

In addition to the growth in total operating income during the period of the financial statements, there was also a rise in the ratio of operating income out of sales. The growth in operating income is attributed to growth in sales of . . . %, together with a lower percentage of growth in operating expenses which were higher by a mere . . . %, i.e. a widening of the gap between sales and operating expenses.

The significance of the higher operating income from the management aspect is that there is efficiency both in absolute and relative terms, when resources are properly utilized. This efficiency is reflected in sales growth and on the other hand, it is being achieved with relatively lower operating expenses, in generating total sales.

1104

In addition to the growth in total operating income during the period of the financial statements, there was also a rise in the ratio of operating income out of sales. The growth in operating income is a result of two contradicting factors. One is the growth in sales by . . . % relative to the previous period and on the other hand, the decline in operating expenses. In other words, a widening of the gap between sales and operating expenses.

The significance of the higher operating income from the management aspect, is that there is efficiency both in absolute and relative terms, and also a proper utilization of resources. This efficiency is reflected in sales growth and on the other hand it is being achieved with less operating expenses, in generating total sales.

1106

In addition to the growth in total operating income during the period of the financial statements, there was also a rise in the ratio of operating income out of sales. The growth in operating income is attributed to two factors. First, growth exhibited in sales of . . . %, relative to the previous period and second, there was no essential change in operating expenses, which amounted to $ . . . (as compared to $ . . . during the previous period). In other words, there was a widening of the gap between sales and operating expenses.

The significance of the higher operating income from the management aspect, is that efficiency is exhibited both in absolute and relative terms, and there is a proper utilization of resources. This efficiency is reflected on the one hand in sales growth and on the other hand, it is being achieved with a similar amount of operating expenses, in generating total sales.

1108

In addition to the growth in total operating income during the period of the financial statements, there was also a rise in the ratio of operating income out of sales. This two-fold growth in operating income occurred despite the decline in sales, indicating that the ratio of decline in operating expenses was greater than the contraction in sales. In other words, there was a widening of the gap between sales and operating expenses.

As a result there was a fallback in business operations owing to the lower sales, despite the positive signs of growth in operating income and in the ratio of operating income out of sales. This positive aspect comes at a time of contraction in sales together with a narrowing of costs and expenses, revealing efficiency and proper utilization of resources.

1110

In addition to the growth in total operating income during the period of the financial statements, there was also a rise in the ratio of operating income out of sales. This was attributed to two factors. One is stability in sales as compared to the previous period, and concomitant with this stability, operating expenses were lower by ______%. In other words, there was a widening of the gap between sales and operating expenses.

This growth in operating income is a positive indicator, from the point of view of management since parallel with stability in sales, there is a decline in costs and expenses, attesting to efficiency and better utilization of resources.

1112

In addition to the decline in total operating income during the period of the financial statements, there was also a decline in its ratio out of sales. The decline in the ratio of operating profit is attributed to a fall in sales ($ ______) parallel with a more moderate reduction in operating expenses ($ ______). In other words, there was a narrowing of the gap between sales and operating expenses.

The decline in operating income is a negative indicator, both in terms of the business and management aspects, and this is problematic. Its reflection in the financial results is apparently attributed to inefficient operations and a failure to properly utilize resources. Inefficiency is reflected both in absolute terms, exhibited in lower operating income, and in relative terms, as demonstrated in the reduction of the ratio of operating income out of sales.

1114

In addition to the reduction in total operating income during the period of the financial statements, there was also a decline in the ratio of operating income out of sales. The reduction in operating income and also its lower ratio out of sales is a result of two contradicting factors. One, the decline in sales by $ . . . as compared to the previous period and on the other hand, the rise in operating expenses totaling $ . . . i.e. a narrowing of the gap between sales and operating expenses.

The decline in operating income and in its ratio out of sales is a negative sign both in terms of the business and management aspects, and this is problematic. Its reflection in the financial results is apparently attributed to inefficient operations and a failure to properly utilize resources. Inefficiency is reflected both in absolute terms, exhibited in lower operating income, and in relative terms, as demonstrated in the reduction of the ratio of operating income out of sales.

1116

In addition to the reduction in total operating income during the period of the financial statements, there was also a decline in the ratio of operating income out of sales. This was attributed to two factors. One is the decline in sales totaling $ . . . as compared to the previous period, and concomitantly there was stability in operating expenses. In other words, there was a narrowing of the gap between sales and operating expenses.

This decline in operating income and in its ratio out of sales is a negative sign both in terms of the business and management aspects, and this is problematic. Its reflection in the financial results is apparently a result of inefficient operations and a failure to properly utilize resources. Inefficiency is reflected both in absolute terms, exhibited in lower operating income, and in relative terms, as demonstrated in the reduction of the ratio of operating income out of sales.

1118

Despite the growth in sales as compared to the previous period, operating income was lower in addition to the decline in the ratio of operating income out of sales. This is attributed to the fact that operating expenses rose at a steeper rate than growth in sales. In other words, there was a narrowing of the gap between sales and operating expenses.

This decline in operating income and in its ratio out of sales is a negative sign both in terms of the business and management aspects, and this is problematic. Its reflection in the financial results is apparently a result of inefficient operations and a failure to properly utilize resources. Inefficiency is reflected both in absolute terms, exhibited in lower operating income, and in relative terms, as demonstrated in the reduction of the ratio of operating income out of sales.

1120

In addition to the reduction in total operating income during the period of the financial statements, there was also a decline in the ratio of operating income out of sales. This was attributed to two factors. One is the stability exhibited in sales as compared to the previous period and concomitantly, operating expenses grew by . . . %. In other words, there was a narrowing of the gap between sales and operating expenses.

This decline in operating income is obviously a negative sign in terms of the management aspect, since stability in sales is accompanied with a deterioration in the utilization of resources both in absolute and relative terms. Sales were achieved at a higher cost than in the previous period.

1122

Despite the growth in total operating income during the period of the financial statements, its ratio out of sales remained essentially unchanged. The stability in operating income is attributed to the . . . % growth in sales and also to a similar rise in operating expenses. Ultimately, there was a widening of the gap between sales and operating expenses.

The significance of this rise in operating income in absolute terms is business expansion and growth in total operations, and this is definitely a positive indication. Nevertheless, the results point to limited success, since there has not been a more efficient utilization of resources as compared with the previous period. This conclusion is reflected in the static nature of the rate of operating income out of sales. In other words, management did not succeed in increasing sales at a lower cost.

1124

Despite the decline in total operating income during the period of the financial statements, its ratio out of sales remained without any essential changed. The stability exhibited in the ratio of operating income out of sales is attributed to a . . . % decline in sales concomitantly with a similar decline in operating expenses. In other words, there was a narrowing of the gap between sales and operating expenses.

This reduction in operating income is not a positive indicator from the business aspect. It is the result of a reduction in total operations. There is, however, a positive side to these business results, as reflected in the stability of the ratio of operating income as compared to the previous period. That is to say, management succeeds in maintaining a proper level of utilization of resources. In this manner, management sends a message that it is in control of operations, quickly adapting to the new situation created, despite the decline in activity. Despite the difficult business environment, at the management level, it appears that matters are under control.

1126

During the period of the financial statements, there was no material change in total operating income as compared to the previous period and also its ratio out of sales remained essentially unchanged. The stability in the rate of operating income is attributed to the stability demonstrated in sales and in operating expenses, which remained essentially unchanged as compared to the previous period. In other words, there was stability in the gap between sales and operating expenses.

1128

The financial results display a rise in total operating income during the period of the financial statements, and concomitantly, a decline in its ratio out of sales. The growth in operating income as compared to the previous period, is obviously attributed to the growth in sales between the two periods ($ . . . ). In contrast, as mentioned, there was a decline in the ratio of operating income out of sales and this is attributed to the fact that there was a more moderate growth in sales (of . . . %) as compared to the growth in operating expenses (of . . . %).

The significance of this rise in operating income in absolute terms, is business expansion and growth in total operations, and this is definitely a positive indication. Nevertheless, the results point to limited success, since there has not been a more efficient utilization of resources as compared with the previous period. This conclusion is reflected in the decline in the ratio of operating income out of sales. In other words, management did not succeed in increasing sales at a lower cost.

1130

The financial results display a decline in total operating income during the period of the financial statements, and concomitantly, growth in its ratio out of sales. The decline in operating income as compared to the previous period, is obviously attributed to the decline in sales between the two periods ($ . . . ). In contrast, as mentioned, there was an increase in the ratio of operating income out of sales and this is attributed to the fact that there was a more moderate decline in sales (of . . . %) as compared to the decline in operating expenses (of . . . %).

This decline in operating income in absolute terms, is not a positive indication. However, there is a positive side to the current situation, and that is the relative increase in efficiency. This is reflected in that, despite the lower sales, the reduced cost in generating such sales is much more significant. This certainly is positive, however, the bottom line, operating income, is measured in absolute amounts of money, and here the success was not satisfactory, compared to the previous period.

1132

Despite the stability in total operating income during the period of the financial statements, concomitantly there was in fact a rise in the ratio of operating income out of sales. The growth in operating income is attributed to the more moderate decline in sales ( of . . . %) as compared to the decline in operating expenses ( . . . %).

This stability in operating income in absolute terms, despite the decline in sales is a positive indication since it reflects increased efficiency. This is being expressed in the cost of generating sales. This certainly is positive, however, the bottom line, operating income, is measured in absolute amounts of money, and here the success was not complete, compared to the previous period.

1134

Despite the stability in total operating income during the period of the financial statements, there was in fact a decline in the ratio of operating income out of sales. The decline in operating income is attributed to the more moderate growth in sales (of . . . %) as compared to the growth in operating expenses (of . . . %).

The stability in absolute terms in operating income despite the growth in sales is not a positive indication, since it reflects unproductive utilization of resources and inefficiency. This is reflected in the higher cost of generating such sales.

APPENDIX I

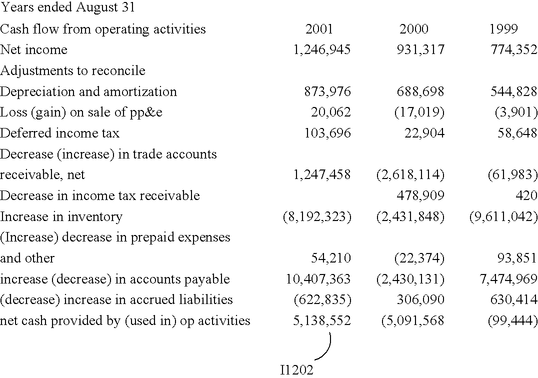

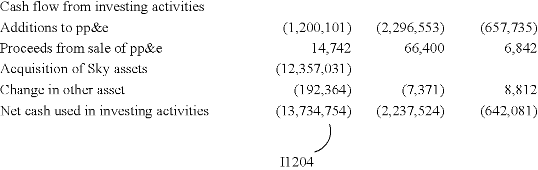

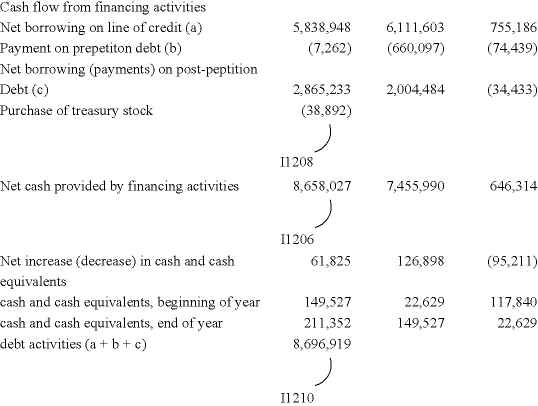

### APPENDIX J

1302

The principal increase in cash and cash equivalents is provided by operating activities, i.e. sales receipts less payment of expenses (totaling $______). This is, of course, the natural and ideal source, and represents a desirable situation whereby receipts are higher than payments of expenses. The surplus cash from operating activities should be used both for investment in assets and operating activities, as well as for payment of liabilities to credit providers and dividends to owners.

Cash provided by operating activities can provide security for investors with respect to the ability to utilize periods of crisis on the market in order to improve positions.

1304

The principal growth in cash and cash equivalents derives from capital raising, totaling $______. Since that is the case, the surplus accumulated cash and cash equivalents is for an interim period until the management utilizes it in accordance with the targets determined during the capital raising operation.

1304

In a situation where the increase in cash derives from capital raising, an examination must be made of the ability to generate cash from operating activities both in the near future and in the long term, but this can be seen in future Financial Statements.

1306

The principal rise in cash and cash equivalents is provided by obtaining credit through loans/debentures, and as aforesaid, totals $______. Because of the gap between the surplus cash yield from short-term investments, and the cost of financing loans/debentures, it may be anticipated that these cash and cash equivalents will be utilized within a short time.

1308

The growth in cash and cash equivalents is provided principally from the proceeds of realizing assets, and as aforesaid, amounts to $______.

1310

The principal decline in cash and cash equivalents, amounting to $______, derives from operating activities, i.e. payments of expenses are higher than sales. This use of cash and cash equivalents is not a positive signal, and represents a lack of profitability, which consumes in addition to financing sources for operating activities, also the financing for investments in assets and repayment of loans to credit providers. In such a situation there is no possibility of distributing dividends or benefiting shareholders.

1312

The principal decline in cash and cash equivalents derives from repayment of loans/debentures, amounting to $______.

1314

The principal decline in cash and cash equivalents, caused by the acquisition of fixed assets/holdings in corporations (see also reference to this issue under the item Fixed Assets/Holdings in Corporations), amounts to $______ as aforesaid. This is a worthwhile policy, whereby cash and cash equivalents, which are not generally reputed to produce high yields, are replaced by assets which will generate growth in the production of sales.

1316

The principal decline in cash and cash equivalents caused by the payment of a dividend to shareholders, amounts to $______. This allocation of cash and cash equivalents to shareholders has both a negative and a positive aspect. Payment of a dividend to shareholders is harmful to cash flow and reduces assets in general, and the corporation's value derived there from in particular. But, on the other hand, such activity constitutes a positive stimulus to shareholders, both present and future.

1318

The principal decline in cash and cash equivalents which flows from the repurchase of shares amounts to $______, as aforesaid. In the short term, the question arises as to the necessity for such a step, since cash and cash equivalents have been expended with no other assets coming in to replace them. As a result, there is a reduction in assets, and in the corporation's value derived there from. On the other hand, the advantage derived by the remaining shareholders from buying back the shares is clear, since the relative proportion of their holdings rises as a result of such action.

1320

The cash and cash equivalents in the Financial Statements as at ______ amount to $______ compared to $______ in the previous period. The significance of these amounts is that there is no material change in the amount of the s cash and cash equivalents.

### APPENDIX K

1402

# Cash in the amount of $ constituting % of the current assets.

1404

# Short term investments amounting to $ ______, constituting ______% of the current assets.

1406

# Accounts receivable amounting to $______ constituting ______% of the current assets.

1408

# Other receivables, non-commercial debtors amounting to $______, constituting ______% of the current assets.

1410

# Inventory in the amount of $______, constituting ______% of the current assets.

1. A method of electronically analyzing primarily financials of an entity, comprising:
receiving primarily financial inputs related to an entity; and
for at least one predetermined relationship: looking up which at least two variables are linked to said predetermined relationship, determining values of said at least two lined variables, evaluating said predetermined relationship using said determined values, selecting less than all interpretative paragraphs associated with said relationship based on results of said evaluating, and outputting said selected less than all paragraphs.

2. The method of claim 1, wherein said selected less than all paragraphs are adapted to include at least part of said determined values.

3. The method of claim 1, wherein said determining includes: computing each value of said at least two variables from at least one of said received inputs.

4. The method of claim 1, wherein a relationship is not evaluated if a test of significance is not passed.

5. The method of claim 1, wherein a relationship is not evaluated if user specified criteria are not fulfilled.

6. The method of claim 1, wherein said relationship is part of a sequence of evaluated relationships and said sequence corresponds to a predetermined order.

7. The method of claim 1, wherein said relationship is part of a sequence of evaluated relationships and said sequence conforms to criteria specified by a user.

8. The method of claim 1, wherein said inputs includes inputs relating to a predetermined period and corresponding inputs related to a period preceding said predetermined period.

9. The method of claim 1, wherein said inputs include inputs for said entity and corresponding inputs for an industry which includes said entity and/or corresponding inputs for a competitor of said entity or entity other than said entity.

10. The method of claim 1, further comprising: outputting graphics illustrating said relationship.

11. The method of claim 10, wherein an appearance of said graphics is dependent on which of said interpretive paragraphs are selected.

12. The method of claim 1, wherein evaluating said relationship includes: comparing magnitude of said determined values with one another.

13. The method of claim 1, wherein evaluating said relationship includes: comparing magnitudes of said determined values against predetermined levels.

14. The method of claim 1, wherein evaluating said relationship includes: verifying that values of all said at least two linked variables have been evaluated.

15-21. (canceled)

22. A method for electronically analyzing primarily financials of an entity, comprising:
receiving primarily financial inputs related to an entity;
analyzing primarily financials of an entity, based on said inputs; and
outputting a textual description and interpretation of analyzed financial of said entity.

23. (canceled)

24. A method of electronically analyzing primarily financials of an entity, comprising:
receiving primarily financial inputs related to an entity; and
for at least on predetermined relationship: looking up which at least one variable is linked to said predetermined relationship, determining a value of said at least one linked variable, evaluating said predetermined relationship using said determined value, selecting or not selecting at least one of at least one interpretative paragraph associated with said relationship based on results of said evaluating, and if at least one of said paragraphs has been selected, outputting said selected at least one of said paragraphs.

25-31. (canceled)

32. The method of claim 1, wherein said selected less than all paragraphs are no paragraphs and therefore zero paragraphs are outputted.

33. (canceled)
